(19) United States
(12) Patent Application Publication
(10) Pub. No.: US 2020/0166909 A1
(43) Pub. Date: May 28, 2020

(54) REAL-TIME ADAPTIVE CONTROL OF MANUFACTURING PROCESSES USING MACHINE LEARNING

(71) Applicant: Relativity Space, Inc., Inglewood, CA (US)

(72) Inventors: Jordan NOONE, Inglewood, CA (US); Tim ELLIS, Inglewood, CA (US)

(21) Appl. No.: 16/688,740

(22) Filed: Nov. 19, 2019

Related U.S. Application Data
(60) Provisional application No. 62/770,034, filed on Nov. 20, 2018.

(51) Int. Cl. G05B 19/4155; G06N 20/00

(52) U.S. Cl. CPC G05B 19/4155; G05B 2219/31372; G06N 20/00

(57) ABSTRACT

Machine learning-based methods and systems for automated object defect classification and adaptive, real-time control of manufacturing processes are described.

### CROSS-REFERENCE

This application claims the benefit of U.S. Provisional Application No. 62/770,034 filed Nov. 20, 2018, which application is incorporated herein by reference.

### BACKGROUND OF THE INVENTION

The use of process automation tools is increasingly prevalent in a variety of different industries. Modern manufacturers are attempting to use these tools to implement cost-effective, high quality, and high throughput parts fabrication and product assembly.

### SUMMARY OF THE INVENTION

Process automation tools can impact both the performance of individual manufacturing process steps and the way in which they are integrated in modern manufacturing plants. Despite progress in the development of automation tools, an unmet need still exists for manufacturing process control methods that allow for rapid optimization and adjustment of the process control parameters in response to changes in process, part design, or environmental parameters, while enabling improvements in the quality of the parts that are produced. Existing process control methods are typically highly specialized, i.e., they are designed for control of a very specific manufacturing process step, and must be extensively optimized (or “tuned”) for a very specific part design or assembly step. Consequently, changes to a manufacturing process or part design often require concomitant changes to the process control system that are time-consuming and costly. Here, various embodiments of methods and systems are disclosed for performing automated, in-process (or real-time) classification of part defects as the part is being fabricated that make use of machine learning algorithms that have been trained using data for the same type of part or, in some cases, for different types of parts as well. These methods and systems provide enhanced flexibility and accuracy in detecting defects as the fabrication process is underway, and may be used to provide real-time feedback that enables adaptive control of fabrication process control parameters. Also disclosed are various embodiments of methods and systems for performing real-time adaptive control of manufacturing processes (including additive manufacturing processes, welding processes, and a variety of other manufacturing processes) that utilize feedback from the disclosed defect classification systems and/or conventional process monitoring tools to improve process yield, throughput, and quality.

Disclosed herein are methods for real-time adaptive control of a manufacturing process (i.e., for real-time adaptive control of a fabrication process rather than a design process), the methods comprising: (a) providing an input design for an object; (b) providing a training data set, wherein the training data set comprises process simulation data, process characterization data, in-process inspection data, post-build inspection data, or any combination thereof, for a plurality of object designs or portions thereof that are the same as or different from the input object design of step (a); (c) providing a starting set or sequence of one or more manufacturing process control parameters for fabricating or assembling the object; and (d) performing the manufacturing process to fabricate or assemble the object, wherein real-time process characterization data or in-process inspection data is provided as input to a machine learning algorithm that has been trained using the training data set of step (b), and wherein the machine learning algorithm provides output values to adjust one or more manufacturing process control parameters in real-time. A novel feature of the disclosed methods is that, in some embodiments, the machine learning algorithm used for real-time adaptive control of the fabrication process is trained on data for a variety of different objects or parts, not just the type of object or part currently being fabricated. For example, in some embodiments, the machine learning algorithm used for real-time adaptive control of a free-form deposition process that has been programmed to fabricate an airline fuselage may be trained using a training data set that comprises process simulation data, process characterization or monitoring data, in-process inspection data, post-build inspection data, or any combination thereof, for rocket engine parts, furniture, molds, turbine blades, etc.

In some embodiments, the starting set or sequence of one or more manufacturing process control parameters is derived using the machine learning algorithm that has been trained using the training data set of step (b). In some embodiments, steps (b)-(d) are performed iteratively and process characterization data, in-process inspection data, or post-build inspection data for each iteration is incorporated into the training data set. In some embodiments, the manufacturing process comprises an additive manufacturing process, a joining process, a forming process, a composite manufacturing process, a subtractive process, a surface preparation process, an inspection process, an assembly process, or any combination thereof. In some embodiments, the additive manufacturing process comprises a deposition process, a chemical vapor deposition process, a painting process, a cold spray process, a high velocity oxygen fuel (HVOF) spraying process, an electrolytic coating process, a sculpting process, a cladding process, or any combination thereof. In some embodiments, the sculpting process comprises surface sculpting, a lithography process, or any combination thereof. In some embodiments, the joining process comprises a welding process, a bonding process, a micro-joining process, a hardfacing process, a butter welding process, or any combination thereof. In some embodiments, the welding process comprises a fusion welding process, a non-fusion welding process, or any combination thereof. In some embodiments, the bonding process comprises an epoxy bonding process, an acrylics bonding process, an acrylates bonding process, a diffusion bonding process, an adhesive bonding process, or any combination thereof. In some embodiments, the micro-joining process comprises a brazing process, a soldering process, or any combination thereof. In some embodiments, the forming process comprises a forging process, an extrusion process, a sheet metal bending process, a superplastic forming process, a blow forming process, a hydroforming process, a break forming process, a casting process, a barreling process, a compacting process, a blooming process, a drawing process, a deep drawing process, a spring forming process, a winding process, a wire process, a knurling process, a rolling process, a saddling process, a spin forming process, an upsetting process, or any combination thereof. In some embodiments, the forging process comprises a punching process, a hammer process, or any combination thereof. In some embodiments, the composite manufacturing process comprises a filament winding process, a layup process, a molding process, an overwrapping process, or any combination thereof. In some embodiments, the subtractive process comprises a cutting process, a turning process, a milling process, a drilling process, a boring process, a trepanning process, an ion beam milling process, a wet chemical etching process, a lithography process, a photochemical process, a dry etching process, an electro discharge machining process, a broaching process, a facing process, a polishing process, a lapping process, a pickling process, a reaming process, a piercing process, a tapping process, a blasting process, an abrasive process, a hobbing process, a ball milling process, a burnishing process, a linishing process, a comminution process, a grinding process, a crushing process, or any combination thereof. In some embodiments, the surface preparation process comprises a painting process, a coating process, or any combination thereof. In some embodiments, the inspection process comprises a non-destructive inspection process, an ultrasonic inspection process, an eddy current inspection process, an X-radiography process, a dye penetrant process, a magnetic penetrant process, an acoustic emission process, or any combination thereof. In some embodiments, the X-radiography process comprises a CT scan process. In some embodiments, the assembly process comprises a press fit process, a tack weld process, a thermal fit process, a riveting process, a mechanical fastener process, or any combination thereof. In some embodiments, the machine learning algorithm comprises an artificial neural network algorithm, a Gaussian process regression algorithm, a logistical model tree algorithm, a random forest algorithm, a fuzzy classifier algorithm, a decision tree algorithm, a hierarchical clustering algorithm, a k-means algorithm, a fuzzy clustering algorithm, a deep Boltzmann machine learning algorithm, a deep convolutional neural network algorithm, a deep recurrent neural network, or any combination thereof. In some embodiments, the one or more manufacturing process control parameters are adjusted at a rate of at least 100 Hz. In some embodiments, the method is implemented using either: (i) a single integrated system comprising a manufacturing apparatus, a sensor, and a processor; or (ii) a distributed, modular system comprising one or more manufacturing apparatus, one or more sensors, and one or more processors, wherein the one or more manufacturing apparatus, the one or more sensors, and the one or more processors are configured to share training data, real-time process characterization data, or real-time in-process inspection data via a local area network (LAN), an intranet, an extranet, or an internet. In some embodiments, the training data set further comprises process characterization data, in-process inspection data, or post-build inspection data that is generated by an operator while manually adjusting the one or more manufacturing process control parameters. In some embodiments, as part of the training of the machine learning algorithm, the machine learning algorithm randomly chooses values within a specified range for each of a set of one or more manufacturing process control parameters, and incorporates the resulting process simulation data, process characterization data, in-process inspection data, or post-build inspection data into the training data set to improve a learned model that maps manufacturing process control parameter values to manufacturing process outcomes.

Also disclosed herein are systems for controlling a manufacturing process (i.e., for controlling a fabrication process rather than a design process), the system comprising: (a) a first manufacturing apparatus, wherein the manufacturing apparatus is capable of fabricating all or a portion of an object based on an input design; (b) one or more manufacturing process characterization sensors, wherein the one or more manufacturing process characterization sensors provide real-time data for one or more manufacturing process parameters or object properties; and (c) a processor programmed to adjust one or more manufacturing process control parameters in real-time based on a stream of real-time process characterization data or in-process inspection data provided by the one or more manufacturing process characterization sensors, wherein the adjustments are derived using a machine learning algorithm that has been trained using a training data set. Again, a novel feature of the disclosed systems is that, in some embodiments, the machine learning algorithm used for real-time adaptive control of the fabrication process is trained on data for a variety of different objects or parts, not just the type of object or part currently being fabricated.

In some embodiments, the processor is further programmed to provide a predicted optimal set of one or more starting manufacturing process control parameters that is derived using the machine learning algorithm. In some embodiments, the first manufacturing apparatus, the one or more manufacturing process characterization sensors, and the processor are configured as: (i) a single integrated system; or (ii) as distributed system modules that share training data and real-time process characterization data or in-process inspection data via a local area network (LAN), an intranet, an extranet, or an internet. In some embodiments, the training data set comprises process simulation data, process characterization data, in-process inspection data, or post-build inspection data for a plurality of objects that are the same as or different from the object of step (a). In some embodiments, the one or more manufacturing process characterization sensors comprise at least one laser interferometer, machine vision system, or sensor that detects electromagnetic radiation that is reflected, scattered, absorbed, transmitted, or emitted by the object. In some embodiments, the one or more process control parameters are adjusted at a rate of at least 100 Hz.

Further disclosed herein are methods for automated classification of manufactured object defects (i.e., in real time as the object is being fabricated), the methods comprising: (a) providing a training data set, wherein the training data set comprises manufacturing process simulation data, manufacturing process characterization data, in-process inspection data, post-build inspection data, or any combination thereof, for a plurality of object designs that are the same as or different from that of the manufactured object; (b) providing one or more sensors, wherein the one or more sensors provide real-time data for one or more manufactured object properties; and providing a processor programmed to provide a classification of detected manufactured object defects using a machine learning algorithm that has been trained using the training data set of step (a), wherein the real-time data from the one or more sensors is provided as input to the machine learning algorithm and allows the classification of detected manufactured object defects to be adjusted in real-time. A novel feature of the disclosed methods for automated classification of manufactured object defects is that, in some embodiments, the machine learning algorithm used for real-time defect classification is trained on data for a variety of different objects or parts, not just the object or part currently being fabricated.

In some embodiments, the method further comprises removing noise from the manufactured object property data provided by the one or more sensors prior to providing it to the machine learning algorithm, wherein the noise is removed using a signal averaging algorithm, smoothing filter algorithm, Kalman filter algorithm, nonlinear filter algorithm, total variation minimization algorithm, or any combination thereof. In some embodiments, the one or more sensors provide data on electromagnetic radiation, acoustic energy, or mechanical energy that is reflected, scattered, absorbed, transmitted, or emitted by the manufactured object. In some embodiments, the one or more sensors comprise vision sensors. In some embodiments, the vision sensors comprise cameras. In some embodiments, the manufactured object defects are detected as differences between manufactured object property data and a reference data set that are larger than a specified threshold, and are classified using a one-class support vector machine (SVM) or autoencoder algorithm. In some embodiments, the manufactured object defects are detected and classified using an unsupervised one-class support vector machine (SVM), autoencoder, clustering, or nearest neighbor (kNN) machine learning algorithm and a training data set that comprises manufactured object property data for defective and defect-free objects.

### INCORPORATION BY REFERENCE

All publications, patents, and patent applications mentioned in this specification are herein incorporated by reference in their entirety to the same extent as if each individual publication, patent, or patent application was specifically and individually indicated to be incorporated by reference in its entirety. In the event of a conflict between a term herein and a term in an incorporated reference, the term herein controls.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 provides a schematic illustration of a machine learning-based system for providing real-time adaptive control of free form deposition processes, e.g., additive manufacturing processes.

FIG. 2 is a schematic diagram of an example set-up for a material deposition process, e.g., a laser-metal wire deposition process, according to some embodiments of the present disclosure.

FIGS. 3A-C provide schematic illustrations of the conversion of a CAD design for a three-dimensional object to a continuous, spiral wound “two-dimensional” layer (of finite thickness) and associated helical tool path (FIG. 3A), or a stacked series of “two-dimensional” layers and associated circular, layer-by-layer tool paths (FIG. 3B) for deposition of material using an additive manufacturing process. FIG. 3C: illustration of the tool path for a robotically manipulated deposition tool and simulation of the resulting object fabricated using an additive manufacturing process.

FIGS. 4A-C provide examples of FEA simulation data for modeling of a laser-metal wire deposition melt pool. FIG. 4A: isometric view of color-encoded three dimensional FEA simulation data for the liquid fraction of material in the melt pool being deposited by a laser-metal wire deposition process. FIG. 4B: cross-sectional view of the FEA simulation data for the liquid fraction of material in the melt pool. FIG. 4C: cross-sectional view of color-encoded three dimensional FEA simulation data for the static temperature of the material in the melt pool.

FIG. 5 is a diagram of one non-limiting example of a specific type of additive manufacturing system, i.e., a laser-metal wire deposition system.

FIGS. 6A-B illustrate one non-limiting example of in-process feature monitoring using interferometry. FIG. 6A: schematic illustration of laser beams used to probe the geometry of the wire feed and melt pool overlaid with a photo of a laser-metal wire deposition process. FIG. 6B: cross-sectional profiles (i.e., height profiles across the width of the deposition) of the wire feed (solid line; peak) and previously deposited layer (solid line; shoulders) and resulting melt pool (dashed line). The x-axis (width) dimension is plotted in arbitrary units. The y-axis (height) dimension is plotted in units of millimeters relative to a fixed reference point below the deposition layer.

FIGS. 7A-C illustrate one non-limiting example of in-process feature extraction from images of a laser-metal wire deposition process obtained using a machine vision system. FIG. 7A: raw image stream obtained from machine vision system. FIG. 7B: processed image after de-noising, filtering, and edge detection algorithms have been applied. FIG. 7C: processed image after application of a feature extraction algorithm.

FIG. 8 illustrates an action prediction—reward loop for a reinforcement learning algorithm according to some embodiments of the present disclosure.

FIG. 9 illustrates reward function construction based on monitoring the actions that a human operator chooses during a manually-controlled deposition process.

FIG. 10 provides a schematic illustration of an artificial neural network according to some embodiments of the present disclosure, and examples of the input(s) and output(s) of a neural network used to provide real-time, adaptive control of an additive manufacturing deposition process.

FIG. 11 provides a schematic illustration of the functionality of a node within a layer of an artificial neural network.

FIG. 12 provides a schematic illustration of an integrated system comprising an additive manufacturing deposition apparatus, machine vision systems and/or other process monitoring tools, process simulation tools, post-build inspection tools, and a processor for running a machine learning algorithm that utilizes data from the machine vision and/or process monitoring tools, the process simulation tools, the post-build inspection tools, or any combination thereof, to provide real-time adaptive control of the deposition process.

FIG. 13 provides a schematic illustration of a distributed system comprising an additive manufacturing deposition apparatus, machine vision systems and/or other process monitoring tools, process simulation tools, post-build inspection tools, and a processor for running a machine learning algorithm that utilizes data from the machine vision and/or process monitoring tools, the process simulation tools, the post-build inspection tools, or any combination thereof, to provide real-time adaptive control of the deposition process. In some embodiments, the different components or modules of the system may be physically located in different workspaces and/or worksites, and may be linked via a local area network (LAN), an intranet, an extranet, or the internet so that process data (e.g., training data, process simulation data, process control data, and post-build inspection data) and process control instructions may be shared and exchanged between the different modules.

FIG. 14 illustrates one non-limiting example of an unsupervised feature extraction and data compression process.

FIG. 15 illustrates the expected outcome for one non-limiting example of an unsupervised machine learning process for classification of object defects.

FIGS. 16A-C provide an example of post-process image feature extraction and correlation with build-time actions. FIG. 16A: image of part after build process has been completed. FIG. 16B: post-build inspection output (CT scan). FIG. 16C: the CT scan image of FIG. 16B after automated feature extraction; automated feature extraction allows one to correlate part features with build-time actions.

FIG. 17 illustrates a non-limiting example of a sheet metal bending machine and how the machine learning approach offers an improvement over conventional processes.

FIG. 18 illustrates a non-limiting example of a spray process and how the machine learning approach offers an improvement over conventional processes.

FIG. 19 illustrates a non-limiting example of a metallic heat treat process and how the machine learning approach offers an improvement over conventional processes.

FIG. 20 illustrates a non-limiting example of a cutting process and how the machine learning approach offers an improvement over conventional processes.

### DETAILED DESCRIPTION

Disclosed herein are methods for automated classification of object defects (i.e., in real time as the object is being fabricated), for example, for objects fabricated using an additive manufacturing process, a welding or joining process, a subtractive manufacturing process, or any of a variety of other manufacturing process, where the methods comprise: a) providing a training data set, wherein the training data set comprises manufacturing process simulation data, manufacturing process characterization data, in-process inspection data, post-build inspection data, or any combination thereof, for a plurality of object designs that are the same as or different from that of the manufactured object; b) providing one or more sensors, wherein the one or more sensors provide real-time data for one or more manufactured object properties; c) providing a processor programmed to provide a classification of detected manufactured object defects using a machine learning algorithm that has been trained using the training data set of step (a), wherein the real-time data from the one or more sensors is provided as input to the machine learning algorithm and allows the classification of detected manufactured object defects to be adjusted in real-time. A novel feature of the disclosed methods is that, in some embodiments, the machine learning algorithm used for real-time classification of object defect is trained on data for a variety of different objects or parts, not just the type of object or part currently being fabricated.

Disclosed herein are methods for real-time adaptive control of a manufacturing process (i.e., for real-time adaptive control of a fabrication process rather than a design process), the methods comprising: a) providing an input design for an object; b) providing a training data set, wherein the training data set comprises process simulation data, process characterization data, in-process inspection data, post-build inspection data, or any combination thereof, for a plurality of object designs or portions thereof that are the same as or different from the input object design of step (a); c) providing a starting set or sequence of one or more manufacturing process control parameters for fabricating or assembling the object, wherein, in some cases, a predicted optimal starting set of one or more process control parameters are derived using a machine learning algorithm that has been trained using the training data set of step (b); and d) performing the manufacturing process to fabricate or assemble the object, wherein real-time process characterization data and/or in-process inspection data is provided as input to the machine learning algorithm trained using the training data set of step (b) to adjust one or more manufacturing process control parameters in real-time. As noted above, a novel feature of the disclosed methods is that, in some embodiments, the machine learning algorithm used for real-time adaptive control of the fabrication process is trained on data for a variety of different objects or parts, not just the type of object or part currently being fabricated. In some embodiments this may include one or any combination thereof, rocket engine parts, furniture, molds, turbine blades, etc.

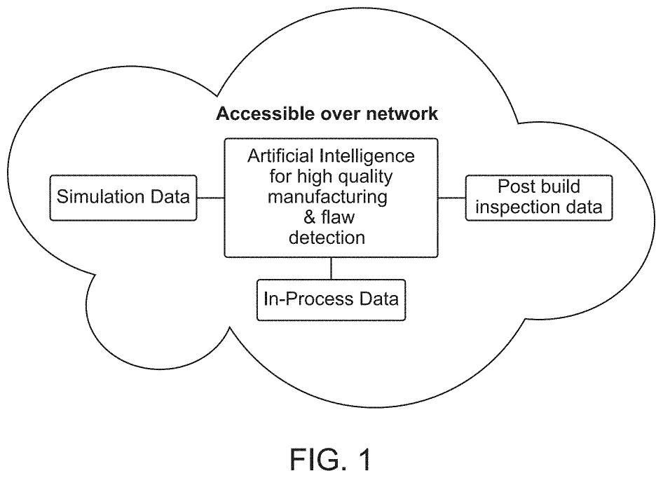

Also disclosed are systems designed to implement these methods, as illustrated schematically in FIG. 1. As indicated in FIG. 1, in some embodiments, the disclosed methods for adaptive, real-time control of manufacturing processes may be implemented using a distributed system, e.g., where different components or modules of the system are physically located in different workspaces, at different work sites, or in different geographical locations, and process simulation data, process characterization data, in-process inspection data, post-build inspection data, and/or adaptive process control instructions are shared and exchanged between locations by means of a telecommunications network or the internet.

In some embodiments, process simulation data may be incorporated into the training data set used by the machine learning algorithm that enables automated classification of object defects, prediction of optimal starting sets or sequences of process control parameters, adjustment of process control parameters in real-time, or any combination thereof. For example, process simulation tools such as finite element analysis (FEA) may be used to simulate the process for fabricating an object or a specific portion thereof, e.g., a feature, from any of a variety of fabrication materials as a function of a specified set of process control parameters. In some embodiments, process simulation tools may be used to predict an optimal starting set or sequence of process control parameters for fabricating a specified object or object feature.

In some embodiments, process characterization (or monitoring) data may be incorporated into the training data set used by the machine learning algorithm that enables automated classification of object defects, prediction of optimal starting sets or sequences of process control parameters, adjustment of process control parameters in real-time, or any combination thereof. For example, process characterization data may be provided by any of a variety of sensors, cameras, or machine vision systems, as will be described in more detail below. In some embodiments, process characterization data may be fed to the machine learning algorithm in order to update the process control parameters of a manufacturing apparatus in real-time.

In some embodiments, in-process or post-build inspection data may be incorporated into the training data set used by the machine learning algorithm that enables automated classification of object defects, prediction of optimal starting sets or sequences of process control parameters, adjustment of process control parameters in real-time, or any combination thereof. For example, in-process or post-build inspection data may include data from visual or machine vision-based measurements of object dimensions, surface finish, number of surface cracks or pores, etc., as will be described in more detail below. In some embodiments, in-process inspection data (e.g., automated defect classification data) may be used by the machine learning algorithm to determine a set or sequence of process control parameter adjustments that will implement a corrective action, e.g., to adjust a layer dimension or thickness in an additive manufacturing process, so as to correct the defect when first detected. In some embodiments, in-process inspection data (e.g., automated defect classification data) may be used by the machine learning algorithm to send a warning or error signal to an operator, or optionally, to automatically abort the manufacturing process, e.g., an additive manufacturing process.

In some embodiments, the training data set is updated with additional process simulation data, process characterization data, in-process inspection data, post-build inspection data, or any combination thereof, after each iteration of an additive manufacturing process that is performed iteratively. In some embodiments, the training data set further comprises process characterization data, in-process inspection data, post-build inspection data, or any combination thereof, that is generated by a skilled operator while manually setting the input process control parameters for a manufacturing process to produce a specified set of objects or parts, or while manually adjusting the process control parameters in response to changes in process parameters or environmental variables to maintain a specified quality of the objects or parts being produced. In some embodiments, the training data set may comprise process simulation data, process characterization data, in-process inspection data, post-build inspection data, or any combination thereof that is collected from a plurality of manufacturing apparatus (or workstations) operating serially or in parallel.

A variety of different machine learning algorithms known to those of skill in the art may be employed to implement the disclosed methods for automated object defect classification and adaptive control of manufacturing processes. Examples include, but are not limited to, artificial neural network algorithms, Gaussian process regression algorithms, fuzzy logic-based algorithms, decision tree algorithms, etc., as will be described in more detail below. In some embodiments, more than one machine learning algorithm may be employed. For example, automated classification of object defects may be implemented using one type of machine learning algorithm, and adaptive real-time process control may be implemented using a different type of machine learning algorithm. In some embodiments, hybrid machine learning algorithms that comprise features and properties drawn from two, three, four, five, or more different types of machine learning algorithms may be employed to implement the disclosed methods and systems.

In some embodiments, the disclosed methods for automated classification of object defects and adaptive real-time control may be implemented using components, e.g., computer numerical control (CNC) milling machines, lathes, additive manufacturing and/or welding apparatus, process control monitors or sensors, machine vision systems, and/or post-build inspection tools, which are co-localized in a specific workspace and which have been integrated to form stand-alone, self-contained systems. In some embodiments, the disclosed methods may be implemented using modular components, e.g., computer numerical control (CNC) milling machines, lathes, additive manufacturing and/or welding apparatus, process control monitors or sensors, machine vision systems, and/or post-build inspection tools, that are distributed over different workspaces and/or different worksites, and that are linked via a local area network (LAN), an intranet, an extranet, or the internet so that process data (e.g., training data, process simulation data, process control data, and post-build inspection data) and process control instructions may be shared and exchanged between the different modules. In some embodiments, a plurality of manufacturing apparatus are linked to the same distributed system so that process data is shared amongst two or more manufacturing apparatus control systems, and used to update the training data set for the entire distributed system.

The disclosed methods and systems for automated object defect classification and adaptive real-time control of manufacturing processes and apparatus may provide for rapid optimization and adjustment of the process control parameters used in response to changes in process or environmental parameters, as well as improved process yield, process throughput, and quality of the parts that are produced. The methods and systems are applicable to parts fabrication in a variety of different technical fields and industries including, but not limited to, the automotive industry, the aeronautics industry, the medical device industry, the consumer electronics industry, etc.

### Definitions

Unless otherwise defined, all technical terms used herein have the same meaning as commonly understood by one of ordinary skill in the art in the field to which this disclosure belongs. As used in this specification and the appended claims, the singular forms “a”, “an”, and “the” include plural references unless the context clearly dictates otherwise. Any reference to “or” herein is intended to encompass “and/or” unless otherwise stated.

As used herein, the term “manufacturing apparatus” may refer either to a stand-alone apparatus or machine (e.g., a stand-alone CNC milling machine, lathe, free form deposition system, welding station, manufacturing workstation, etc.) or a cluster of two or more of the same or dissimilar apparatuses or machines. In the latter case, the cluster of machines may be co-located in the same physical location, or may be distributed among two or more different physical locations at the same geographical site, or at different geographical locations. In some cases, the manufacturing apparatus (stand-alone or clustered) may optionally include one or more process monitoring and/or object property monitoring sensors or tools. Typically, a manufacturing apparatus will be configured to send and/or receive process monitoring data, object property or inspection data, and/or process control data to/from one or more processors that may be co-located with the manufacturing apparatus or located remotely.

As used herein, the term “manufacturing system” may refer to a system comprising one or more manufacturing apparatuses, one or more process monitoring and/or object property monitoring sensors or tools (if not directly integrated with the manufacturing apparatuses), and one or more processors configured to implement the disclosed methods for automated real-time object defect classification and real-time, adaptive control of manufacturing processes.

As used herein, the term “object” may refer to a layer (e.g., a coating layer or paint layer) or portion thereof, a substantially two-dimensional part (e.g., a stamped sheet metal part or a flat steel plate of finite thickness) or portion thereof, a three-dimensional part (e.g., an engine block) or portion thereof, or an assembly of two or more parts. In some cases, the term “object” may be used interchangeably with “part”.

As used herein, the terms “deposition process” and “free form deposition process” may refer to any of a variety of liquid-to-solid free form deposition processes, solid-to-solid free form deposition processes, additive manufacturing processes, welding processes, and the like. In some embodiments, the disclosed methods and systems may be applied to any of a variety of additive manufacturing processes, including, but not limited to, fused deposition modeling (FDM), selective laser sintering (SLS), or selective laser melting (SLM), as will be described in more detail below. In some preferred embodiments, the additive manufacturing process may comprise a liquid-to-solid free form deposition process, e.g., a laser-metal wire deposition process, or a welding process, e.g., a laser welding process.

As used herein, the term “joining process” may refer to any of a variety of welding processes, bonding processes, micro-joining processes, hardfacing processes, butter welding processes, or any combination thereof.

As used herein, the term “data stream” refers to a continuous or discontinuous series or sequence of analog or digitally-encoded signals (e.g., voltage signals, current signals, image data comprising spatially-encoded light intensity and/or wavelength data, etc.) used to transmit or receive information.

As used herein, the term “process window” refers to a range of process control parameter values for which a specific manufacturing process yields a defined result. In some instances, a process window may be illustrated by a graph of process output plotted as a function of multiple process control parameters, with a central region indicating the range of parameter values for which the process behaves well, and outer borders that define regions where the process becomes unstable or returns an unfavorable result.

As used herein, the term “machine learning” refers to any of a variety of artificial intelligence or software algorithms used to perform supervised learning, semi-supervised learning, unsupervised learning, reinforcement learning, or any combination thereof.

As used herein, the term “real-time” refers to the rate at which sensor data is acquired, processed, and/or used in a feedback loop with a machine learning algorithm to update a classification of object defects or to update a set or sequence of process control parameters in response to changes in one or more input process data streams comprising process simulation data, process characterization data, in-process inspection data, post-build inspection data, or any combination thereof.

Manufacturing Processes:

The disclosed methods and systems for automated object defect classification and real-time adaptive control of manufacturing processes may be used with any of a variety of manufacturing processes known to those of skill in the art. Examples include, but are not limited to, additive manufacturing processes, joining processes, forming processes, composite manufacturing processes, subtractive manufacturing processes, surface preparation processes, inspection processes, assembly processes, or any combination thereof.

Examples of additive manufacturing processes include, but are not limited to, deposition processes, chemical vapor deposition processes, painting processes, cold spray processes, high velocity oxyfuel processes, electrolytic coating processes, a sculpting process, a cladding process, or any combination thereof. Free form deposition or additive manufacturing processes, e.g., 3D printing processes and the like, will be discussed in more detail below.

Chemical vapor deposition processes are used to produce high quality, high-performance, solid materials, typically under vacuum. CVD typically involves injecting a precursor gas or gases into a vacuum chamber containing one or more heated objects to be coated. Chemical reactions occur on and near the hot surfaces, resulting in the deposition of a thin film on the surface. The majority of its applications involve applying solid thin-film coatings to surfaces, but it may also be used to produce high-purity bulk materials and powders, as well as fabricating composite materials via infiltration techniques. The process is often used in the semiconductor industry to produce thin films. Examples of process control parameters that may be subject to control by the methods and systems disclosed herein include, but are not limited to, gas influx rate, vacuum level, temperature, and any combination thereof.

Painting processes are used to form a coating film on the surface of an object in order to protect the object or give a fine appearance. There are various types of painting methods, and spray painting is currently used in many types of industrial painting. Examples of industrial spray painting processes include painting processes performed in a wet booth or painting processes performed in a dry booth. Examples of process control parameters that may be subject to control by the methods and systems disclosed herein include, but are not limited to, coating material viscosity, one or more mixing ratios (e.g., for mixing the coating material with a paint thinner prior to spraying), type of spray nozzle, spray nozzle efflux rate, spray nozzle distance (from object to be painted), spray nozzle velocity (relative to object to be painted), exhaust volumetric flowrate, drying furnace temperature, drying furnace transit time, drying furnace exhaust volumetric flowrate, and any combination thereof.

Cold spray processes are coating deposition methods in which solid powders (e.g., powders comprising particles of 1 to 50 micrometers in diameter) are accelerated in a supersonic gas jet (at velocities of up to 500-1000 m/s) that is directed towards a substrate using a scanning spray nozzle. Upon impact with the substrate, the particles undergo plastic deformation and adhere to the surface. Metals, polymers, ceramics, composite materials and nanocrystalline powders can be deposited using cold spraying. Unlike thermal spraying techniques, e.g., plasma spray processes, the powders are not melted during the spraying process. Examples of process control parameters that may be subject to control by the methods and systems disclosed herein include, but are not limited to, gas jet velocities, types of powders to be deposited, type of scanning spray nozzle, distance of scanning spray nozzle from the substrate, and any combination thereof.

High velocity oxygen fuel (HVOF) spraying processes comprise feeding a mixture of gaseous or liquid fuel (e.g., hydrogen, methane, propane, propylene, acetylene, natural gas, kerosene, etc.) and oxygen into a combustion chamber, where the mixture is ignited and combusted continuously. The resultant hot gas exits the chamber under high pressure through a converging-diverging nozzle at jet velocities that exceed the speed of sound (e.g., >1000 m/s). A powder feed stock is injected into the gas stream, which accelerates the powder particles to velocities of up to, e.g., 800 m/s. The stream of hot gas and powder particles is directed towards the surface to be coated. The particles partially melt in the stream and are deposited on the substrate, resulting in a coating that has low porosity and high bond strength. HVOF coatings may be as thick as 12 mm (½″) and are typically used to deposit wear and corrosion resistant coatings (e.g., chromium carbide, alumina, etc.) on substrate materials. Examples of process control parameters that may be subject to control by the methods and systems disclosed herein include, but are not limited to, temperature, gas jet velocities, types of gaseous or liquid fuel used, fuel/oxygen mixing ratio, size of combustion chamber, type of converging-diverging nozzle, distance of converging-diverging nozzle from the surface to be coated, and any combination thereof.

Electrolytic coating or plating (i.e., electroplating) processes are processes by which a thin layer of metal is deposited on another metal, plastic, or other substrate material that is, or has been made electrically-conductive. The process occurs in a highly conductive, electrolytic solution. Direct current is used for electroplating. The positively charged plating metal ions within the electrolytic solution are precipitated, or drawn out of the solution to coat the negatively charged conductive part surface. As current flows, the metal ions in the solution gain electrons at the part surface and are transformed into a metal coating. The positively charged plating metal is referred to as the ‘anode’, while the part to be plated is called the ‘cathode’. Examples of process control parameters that may be subject to control by the methods and systems disclosed herein include, but are not limited to, the composition and/or ionic strength of the electrolytic solution, the current setting, the time duration for which the current is applied, and any combination thereof.

Sculpting processes are processes in which subtractive techniques (e.g., chipping or carving), additive techniques (e.g., modeling), or assembly techniques (e.g., joining of pre-fabricated components) are used to create substantially two-dimensional (relief) features or parts, or three-dimensional (free standing) features or parts. In some cases, a sculpting process may comprise a surface sculpting process. In some cases, a surface sculpting process may comprise a lithography process. Examples of process control parameters that may be subject to control by the methods and systems disclosed herein include, but are not limited to, tool selection (e.g., the types and sizes of tools used for any of the aforementioned techniques), tool advancement rate, tool rotation rate, the amount of time each of the aforementioned tools are used, and any combination thereof.

Cladding processes are processes comprising the application of one material over another substrate material to provide a thin layer or coating that confers a different physical or chemical property to the underlying object or part. Any of a variety of materials (metals, glasses, semiconductors, ceramics, polymers, etc.) may be used as the substrate material or the cladding material, and may be used to confer such properties as thermal insulation, weather resistance, chemical resistance, electrical insulation, changes in optical index of refraction, etc., to an underlying object or part. Examples of process control parameters that may be subject to control by the methods and systems disclosed herein include, but are not limited to, bonding material selection, bonding material layer thickness, temperature, applied pressure, and any combination thereof.

In metalworking, cladding is a bonding process for joining dissimilar metals that differs from fusion welding or gluing. Cladding is often achieved by extruding two metals through a die as well as by pressing or rolling sheets of metal together under high pressure. In some cases, cladding is used to enable the use of a less expensive metal as “filler” between thinner layers of a more expensive metal. Examples of process control parameters that may be subject to control by the methods and systems disclosed herein include, but are not limited to, rolling pressure, extrusion pressure, temperature, and any combination thereof.

Examples of joining processes include, but are not limited to, welding processes, bonding processes, micro-joining processes, hardfacing processes, butter welding processes, or any combination thereof.

Welding processes may comprise fusion welding processes (i.e., welding processes that rely on melting to join materials of similar compositions and melting points), non-fusion welding processes (i.e., welding processes that do not rely on melting to join materials (e.g., soldering, brazing, bronze welding, and spot welding)), or any combination thereof. Specific examples of welding processes will be discussed in more detail below.

Bonding processes may comprises epoxy bonding processes, acrylics bonding processes, acrylates bonding processes, diffusion bonding processes, adhesive bonding processes, or any combination thereof. Examples of process control parameters that may be subject to control by the methods and systems disclosed herein include, but are not limited to, adhesive material selection, coating thickness, bonding temperature, processing time, chamber pressure, tool pressure, and any combination thereof.

Diffusion bonding processes comprise processes for joining similar and dissimilar metals in which the atoms of two solid, metallic surfaces intersperse themselves over time. These processes typically require the use of elevated temperatures and high pressure. The technique is often used to bond alternating layers of thin metal foil, and metal wires or filaments. Examples of process control parameters that may be subject to control by the methods and systems disclosed herein include, but are not limited to, temperature, applied pressure, and any combination thereof.

Micro-joining processes may comprise brazing processes, soldering processes, and the like, or any combination thereof. Brazing (or soldering) is a metal joining process in which two or more metal items are joined together by melting a filler metal and allowing it to flow into the joint, the filler metal having a lower melting point than the adjoining metal. Examples of process control parameters that may be subject to control by the methods and systems disclosed herein include, but are not limited to, temperature (e.g., soldering iron temperature), solder or brazing material selection, solder or brazing material feed rate, flux selection, and the like, or any combination thereof.

Examples of forming processes include, but are not limited to, forging processes, extrusion processes, sheet metal bending processes, superplastic forming processes, blow forming processes, hydroforming processes, break forming processes, casting processes, barreling processes, compacting processes, blooming processes, drawing processes, deep drawing processes, spring forming processes, winding processes, wire processes, knurling processes, rolling processes, saddling processes, spin forming processes, upsetting processes, or any combination thereof.

Forging processes may comprise any of a variety of manufacturing processes for shaping metal parts using localized compressive forces that are typically delivered by a hammer and/or die. Examples include, but are not limited to, a punching process, a hammering process, a drop forging process, etc., or any combination thereof. Examples of process control parameters that may be subject to control by the methods and systems disclosed herein include, but are not limited to, temperature, pressure, impact force, tool selection (e.g., tool type, tool shape, and tool dimensions), tensile strength of the workpieces, and any combination thereof.

Extrusion processes comprise a process used to create objects of a fixed cross-sectional profile. In some embodiments, a material is pushed through a die of the desired cross-section. Examples of process control parameters that may be subject to control by the methods and systems disclosed herein include, but are not limited to, material selection, die selection, temperature, extrusion pressure, extrusion rate, or any combination thereof.

Sheet metal bending processes comprise a forming operation in which a metal sheet is subjected to a bending stress whereby a flat planar sheet is made into a bent or curved sheet. In some embodiments, the sheet gets plastically deformed without a change in thickness. Examples of process control parameters that may be subject to control by the methods and systems disclosed herein include, but are not limited to, bending force, bending rate, bending temperature, and the like, or any combination thereof.

Superplastic forming processes comprise specialist processes used for subjecting metal sheet materials to extremely large plastic strains to deform the material and produce thin-walled components to near-net shape. During superplastic forming, the metal sheet material is stretched to a much larger extent than that induced by rolling or sheet forming processes, e.g., stretching the material at least 200% beyond its original size and exceeding 1,000% with some metals. The basic steps involved in superplastic forming of metal sheet comprise placing the sheet within a die cavity and then heating while high gas pressure is evenly applied to plastically deform the metal at very large strains into a single-piece component comprising a complex shape. Examples of process control parameters that may be subject to control by the methods and systems disclosed herein include, but are not limited to, working temperature, heating rate, cooling rate, gas pressure, the time duration over which pressure/strain is applied, and any combination thereof.

Blow forming processes are specific manufacturing process by which hollow plastic parts are formed and can be joined together. Blow forming can also be used for forming glass bottles or other hollow shapes. In general, there are three main types of blow molding: extrusion blow molding, injection blow molding, and injection stretch blow molding. The blow molding process begins with melting the plastic and forming it into a parison, or in the case of injection and injection stretch blow molding (ISB), a preform. The parison is a tube-like piece of plastic with a hole in one end through which compressed air can pass. Examples of process control parameters that may be subject to control by the methods and systems disclosed herein include, but are not limited to, melt temperature, heating rate, extrusion rate, extrusion volume, injection rate, injection volume, cooling rate, and any combination thereof.

Hydroforming processes relate to a metal fabricating and forming process which allows the shaping of metals such as steel, stainless steel, copper, aluminum, and process. In some embodiments, the process is a specialized type of die molding that utilizes highly pressured fluid to form metal. Examples of process control parameters that may be subject to control by the methods and systems disclosed herein include, but are not limited to, fluid pressure, fluid temperature, work piece temperature, time duration for application of fluid pressure, and any combination thereof.

Break forming processes relate to a deformation process whereby, in some embodiments, a linear feature is formed in a piece of sheet metal along a specified straight axis. In some embodiments, this may be accomplished by a “V”-shaped, “U”-shaped or channel shaped punch and die set. Examples of process control parameters that may be subject to control by the methods and systems disclosed herein include, but are not limited to, work piece temperature, applied force, impulse force, release rate, and any combination thereof.

Casting processes relate to a manufacturing process in which a liquid material is usually poured into a mold, which contains a hollow cavity of the desired shape, and then allowed to solidify. The solidified part is also known as a casting, which is ejected or broken out of the mold to complete the process. Examples of process control parameters that may be subject to control by the methods and systems disclosed herein include, but are not limited to, liquid temperature, mold temperature, rates at which liquid and/or mold temperatures are ramped, time duration over which the liquid is allowed to solidify, and any combination thereof.

Barreling (or tumbling) processes relate to a process for smoothing and polishing a rough surface on relativity smart parts, where the process often includes the use of an abrasive grit and/or lubricant. Examples of process control parameters that may be subject to control by the methods and systems disclosed herein include, but are not limited to, abrasive grit selection (e.g., composition, coarseness, etc.), volume of abrasive grit used, lubricant selection (e.g., composition), volume of lubricant used, tumbling rate, and any combination thereof.

Compacting processes involve taking finely sized powders and compressing these into a solid shape which can be a flat sheet, corrugated sheet, or in stick form. Examples of process control parameters that may be subject to control by the methods and systems disclosed herein include, but are not limited to, powder size selection, powder composition, powder mixing ratios, compression force applies, time duration for compression, and any combination thereof.

Rolling processes are metal forming processes in which metal stock is passed through one or more pairs of rollers to reduce the thickness and to make the thickness uniform. Rolling is classified according to the temperature of the metal rolled, and may include hot rolling (i.e., if the temperature of the metal is above its recrystallization temperature), or cold rolling (i.e., if the temperature of the metal is below its recrystallization temperature). Other types of rolling processes include ring rolling, roll bending, roll forming, profile rolling, and controlled rolling. In blooming processes, blooms (e.g., intermediate-stage pieces of steel produced by a first pass of rolling that works the ingots down to a smaller cross-sectional area, but where the area is still greater than 36 in²) are rolled into billets (e.g., lengths of metal that have a round or square cross-section of area less than 36 in²). Examples of rolling process control parameters that may be subject to control by the methods and systems disclosed herein include, but are not limited to, input material thickness, output material thickness, rolling temperature (e.g., the temperature at which the material is maintained during the rolling process), pressure or force applied by the rollers to the material being processed, and any combination thereof.

Drawing processes relate to a metalworking process which uses tensile forces to stretch metal or glass. As the metal is drawn (pulled), it stretches thinner, into a desired shape and thickness. Drawing processes are classified in two types: (i) sheet metal drawing, and (ii) wire, bar, and tube drawing. Examples of process control parameters that may be subject to control by the methods and systems disclosed herein include, but are not limited to, heating rate, temperature, cooling rate, tensile force, and any combination thereof.

Deep drawing processes relate to a sheet metal forming process in which a sheet metal blank is radially drawn into a forming die by the mechanical action of a punch. It is thus a shape transformation process with material retention. Examples of process control parameters that may be subject to control by the methods and systems disclosed herein include, but are not limited to, heating rate, working temperature, cooling rate, applied force, and any combination thereof.

Spring forming processes use mechanical spring machinery to create springs by coiling, winding, or bending spring wire into the shape of a specific spring. Examples of process control parameters that may be subject to control by the methods and systems disclosed herein include, but are not limited to, spring wire selection (e.g., composition, diameter), working temperature, heating and cooling rate, coiling, winding or bending force applied, and any combination thereof.

Winding processes relate to the transfer of winding string, twine, cord, thread, yarn, rope, wire, ribbon, tape, etc., onto a spool, bobbin, reel, cone, pirn, etc. Examples of process control parameters that may be subject to control by the methods and systems disclosed herein include, but are not limited to, winding rate (e.g., rotation rate of the spool, bobbin, etc., on which the material is being wound), tension, and any combination thereof.

Wire processes relate to a metalworking process used to reduce the cross-section of a wire by pulling the wire through a series of one or more drawing die(s). There are many applications for wire drawing, including electrical wiring, cables, tension-loaded structural components, springs, paper clips, spokes for wheels, and stringed musical instruments. Although similar in process, drawing is different from extrusion, because in drawing the wire is pulled, rather than pushed, through the die. Wire drawing is usually performed at room temperature, thus classified as a cold working process, but it may be performed at elevated temperatures for large wires to reduce forces. Examples of process control parameters that may be subject to control by the methods and systems disclosed herein include, but are not limited to, draw rate, draw temperature, material pre-heating temperature, etc., and any combination thereof.

Knurling processes relate to a manufacturing process, typically conducted on a lathe, whereby a pattern of straight, angled or crossed lines is rolled into the material. Examples of process control parameters that may be subject to control by the methods and systems disclosed herein include, but are not limited to, cutting tool selection (e.g. shape, diameter, etc.), tool advancement rate, tool advancement distance, rotation rate of work piece, and any combination thereof.

Saddling processes, sometimes referred to as mandrel forging, relates to a forging operation that is performed with the help of a tool called a mandrel. In some embodiments, a mandrel comprises a blunt ended tool or rod that is used to enlarge or retain the cavity in a hollow product, often a metal product, during forging. Examples of process control parameters that may be subject to control by the methods and systems disclosed herein, but are not limited to, temperature, rotation rate of the mandrel, rotation rate of one or more surrounding rollers relative to the mandrel, or any combination thereof.

Spin forming processes relate to a metalworking process by which a disc or tube of metal is rotated at high speed and formed into an axially symmetric part. In some embodiments, spinning can be performed by hand or by a CNC lathe. Examples of process control parameters that may be subject to control by the methods and systems disclosed herein include, but are not limited to, working temperature, heating rate, cooling rate, rotation rate, and any combination thereof.

Upsetting processes (or upset forging processes) relate to a deformation process in which a (usually round) billet is compressed between two dies in a press or a hammer. This operation reduces the height of a part while increasing its diameter. The process is mostly used as an intermediate step in multiple step forging operations. Examples of process control parameters that may be subject to control by the methods and systems disclosed herein include, but are not limited to, working temperature, heating rate, cooling rate, compression force, and any combination thereof.

Examples of composite manufacturing processes include, but are not limited to, filament winding processes, layup processes, molding processes, overwrapping processes, or any combination thereof.

Filament winding processes relate to a fabrication technique mainly used for manufacturing open (cylinders) or closed end structures (pressure vessels or tanks). This process involves winding filaments under tension over a rotating mandrel. The mandrel rotates around the spindle (Axis 1 or X: Spindle) while a delivery eye on a carriage (Axis 2 or Y: Horizontal) traverses horizontally in line with the axis of the rotating mandrel, laying down fibers in the desired pattern or angle. Examples of process control parameters that may be subject to control by the methods and systems disclosed herein include, but are not limited to, working temperature, axis 1 rotation rate, delivery eye (axis 2) traverse rate, filament tension, and any combination thereof.

Layup processes relate to a molding process where fiber reinforcements are placed (by machine or by hand) and then wet with resin to bond them in place and form a composite material. In some embodiments, the manual nature of this process allows for almost any reinforcing material to be considered, e.g., chopped strand or mat. Examples of process control parameters that may be subject to control by the methods and systems disclosed herein include, but are not limited to, rotation rate about one or more axes, tension applied to the fiber being places, working temperature, and any combination thereof.

Molding processes relate to the process of manufacturing by shaping liquid or pliable raw material using a rigid frame sometimes referred to as a mold or a matrix, where the liquid or pliable material may be hardened within the mold or matrix. Examples of process control parameters that may be subject to control by the methods and systems disclosed herein include, but are not limited to, mixing ratios for liquid materials and hardeners, input material temperature, mold temperature, time duration in mold, and any combination thereof.

Overwrapping processes, sometimes referred to filament winding, are used primarily for wrapping hollow, generally circular or oval sectioned components such as pipes and tanks. In some embodiments, fibre tows are passed through a resin bath before being wound onto a mandrel in a variety of orientations, controlled by the fibre feeding mechanism and rate of rotation of the mandrel. Examples of process control parameters that may be subject to control by the methods and systems disclosed herein, but are not limited to, translation distance of the fibre feeding mechanism, translation rate of the fibre feeding mechanism, rotational rate of the mandrel, or any combination thereof.

Examples of subtractive manufacturing processes include, but are not limited to, cutting processes, turning processes, milling processes, drilling processes, boring processes, trepanning processes, ion beam milling processes, wet chemical etching processes, lithography processes, photochemical processes, dry etching processes, electro discharge machining processes, broaching processes, facing processes, polishing processes, lapping processes, pickling processes, reaming processes, piercing processes, tapping processes, blasting processes, abrasive processes, hobbing processes, ball milling processes, burnishing processes, linishing processes, comminution processes, grinding processes, crushing processes, or any combination thereof. Selected examples of these processes are described in more detail below.

Trepanning processes relate to a drilling process that cuts only at the periphery of a hole and leaves a core remaining. Trepanning is a deep hole drilling process that has broad application over many industries. In many cases, trepanning is meant to be a roughing operation to be honed for finish or machined further. In other cases, the trepanned hole is fit for use “as-drilled”. Examples of process control parameters that may be subject to control by the methods and systems disclosed herein include, but are not limited to, bit selection (e.g., diameter, design, etc.), bit rotation rate, bit advancement rate, and any combination thereof.

Ion beam milling processes relate to a physical etching technique. In some embodiments, the ions of an inert gas are accelerated from a wide beam ion source into the surface of a substrate (or coated substrate) in vacuum to remove material to some desired depth or to expose an underlayer. Examples of process control parameters that may be subject to control by the methods and systems disclosed herein include, but are not limited to, voltage and/or current applied to a pair of discharge electrodes, gas (e.g., argon) pressure, voltage applied to ion acceleration electrodes or grids, degree of vacuum maintained in the milling chamber, tilt angle between ion beam and work piece, rotation rate of work piece, and any combination thereof.

Wet chemical etching processes are processes that utilize liquid chemicals to remove material. In some embodiments, the process involves immersion of a substrate in a pure chemical or mixture of chemicals for a specified amount of time. The amount of time is related to the choice of etchant solution, the composition and thickness of the layer to be etched, and the temperature to be used. Examples of process control parameters that may be subject to control by the methods and systems disclosed herein include, but are not limited to, mixing ratios for etchant composition, working temperature, time duration for etching, number of rinse cycles, time duration of rinse cycles, etc., and any combination thereof.

Lithography processes in general relate to processes for creating patterns on a surface. Photolithography processes relate to processes for patterning surfaces by selective exposure of a layer of a photosensitive resist (i.e., a photoresist) coated on a substrate to be etched. A positive resist is a photoresist in which the portion of the photoresist that is exposed to light becomes soluble to the developer solution. The unexposed portion of the photoresist remains insoluble to the developer and forms a protective, patterned layer on the substrate surface. A negative photoresist is a photoresist in which the portion of the photoresist that is exposed to light becomes insoluble to the developer solution. The unexposed portion of the photoresist is dissolved by the developer solution. Following the development of the resist, the substrate is chemically etched in the exposed areas to remove material. The process is used in a variety of industries to, for example, create patterned sheet metal parts, patterned glass surfaces, patterned semiconductor chips, etc. Photochemical processing, in some embodiments, may refer to a combination of photolithography and wet chemical etching. Examples of process control parameters that may be subject to control by the methods and systems disclosed herein include, but are not limited to, photoresist selection (composition, viscosity, etc.), photoresist application volume, photoresist application spin rate (e.g., if a spin-coater is used), photoresist cure time and temperature, photoresist exposure wavelength, photoresist exposure time, developer selection (composition, etc.), development time duration, and any combination thereof.

Dry etching processes relate to the removal of material by exposing the material to a series of ions that dislodge portions of the material from the exposed surface. In some embodiments, the ions comprise a plasma of reactive gases such as fluorocarbons, oxygen, chlorine, boron trichloride; sometimes with addition of nitrogen, argon, helium. Examples of process control parameters that may be subject to control by the methods and systems disclosed herein include, but are not limited to, voltage and/or current applied to a pair of discharge electrodes, gas pressure, voltage applied to ion acceleration electrodes or grids, degree of vacuum maintained in the milling chamber, tilt angle between ion beam and work piece, rotation rate of work piece, and any combination thereof.

Electro discharge machining processes relate to a manufacturing process where a desired shape is obtained by using electrical discharges (sparks). In some embodiments, material is removed from a work piece by a series of rapidly recurring current discharges between the two electrodes, separated by a dielectric liquid and subject to an electric voltage. In some embodiments, the process turns upon the tool and work piece making actual contact or not. Examples of process control parameters that may be subject to control by the methods and systems disclosed herein include, but are not limited to, current and/or voltage applied to discharge electrodes and the work piece, dielectric liquid selection (e.g., composition, dielectric strength, etc.), separation distance between the discharge electrode(s) and the work piece, and any combination thereof.

Broaching processes relate to a machining process that uses a toothed tool, called a broach, to remove material. Examples of process control parameters that may be subject to control by the methods and systems disclosed herein include, but are not limited to, tool selection (dimensions and spacing of teeth), tool advancement rate, tool advancement depth, linear translation rate of tool, rotation rate of work piece, and any combination thereof.

Facing processes relate to the process of removing metal from the end of a workpiece to produce a flat surface. Examples of process control parameters that may be subject to control by the methods and systems disclosed herein include, but are not limited to, tool selection (dimensions, number of cutting edges, cutting edge angle, etc.), tool advancement rate, tool advancement depth, linear translation and/or rotational rate of tool and/or work piece, and any combination thereof.

Polishing processes relate to smoothing a workpiece surface using an abrasive and a work wheel or a leather strop. Lapping processes relate to a machining process in which two surfaces are rubbed together with an abrasive between them, by hand movement or using a machine. Examples of process control parameters that may be subject to control by the methods and systems disclosed herein include, but are not limited to, abrasive selection (e.g., grit composition, grit size, etc.), translational and/or rotational rate of polishing wheel, strop, or of one part relative to another, and any combination thereof.

Pickling processes relate to a process of treating metal surfaces to remove impurities. In some embodiments, these impurities comprise a metal surface treatment used to remove impurities, such as stains, inorganic contaminants, rust or scale from ferrous metals, copper, precious metals, or aluminum alloys. Various chemical solutions are usually used to remove these impurities. Strong acids, such as hydrochloric acid and sulfuric acid are common, but different applications use also various other acids. Also alkaline solutions can be used for cleaning metal surfaces. Solutions usually also contain additives such as wetting agents and corrosion inhibitors. Examples of process control parameters that may be subject to control by the methods and systems disclosed herein include, but are not limited to, pickling solution composition, pH, ionic strength, temperature, duration of treatment, number of rinse cycles, etc., and any combination thereof.

Reaming processes relate to using a rotary cutting tool (i.e., a reamer) in, for example, metalworking to enlarge the size of a previously formed hole by a small amount but with a high degree of accuracy. Examples of process control parameters that may be subject to control by the methods and systems disclosed herein include, but are not limited to, reamer dimension, reamer design, temperature, reamer rotation rates, translation rate of machine or operative movement along axis perpendicular to hole, etc., and any combination thereof.

Piercing processes relate to shearing process where a punch and die are used to modify foils, metals, papers, textiles, plastic films, and other web materials. Examples of process control parameters that may be subject to control by the methods and systems disclosed herein include, but are not limited to, tension applied to the web material, punch rate, punch & die selection, and any combination thereof.

Tapping processes relate to cutting a thread inside a hole so that a cap screw or bolt can be threaded into the hole. Examples of process control parameters that may be subject to control by the methods and systems disclosed herein include, but are not limited to, tap selection (e.g., diameter, thread type, etc.), tool rotation rate, tool advancement rate, and any combination thereof.

Blasting processes relate to processes in which an abrasive (e.g., sand or other fine grit material) is propelled in a high velocity air or gas stream against a surface to smooth and/or shape it. Abrasive processes relate to processes in which an abrasive (e.g., garnet, emery, aluminum oxide, silicon carbide, etc.), which may be attached to a paper or cloth backing or may be applied as a slurry (particles suspended in a carrier liquid), is used to smooth or polish a surface. Examples of process control parameters that may be subject to control by the methods and systems disclosed herein include, but are not limited to, grit selection (type, size, etc.), air or gas stream nozzle shape and size, distance of air or gas stream nozzle from surface, translation rate of air or gas stream nozzle relative to the surface, rotational and or translational rate of abrasive sheet or abrasive slurry relative to the work piece, etc., and any combination thereof.

Hobbing processes relate to a machining process for gear cutting, cutting splines, and cutting sprockets on a hobbing machine, which is a special type of milling machine. The teeth or splines are progressively cut into the workpiece by a series of cuts made by a cutting tool called a hob. Examples of process control parameters that may be subject to control by the methods and systems disclosed herein include, but are not limited to, bit or cutter selection (e.g., size and shape), bit or cutter advancement rate, bit or cutter advancement depth, and any combination thereof.

Ball milling processes relate to grinding methods that grind compounds into extremely fine powders. Examples of process control parameters that may be subject to control by the methods and systems disclosed herein include, but are not limited to, grinding medium selection (e.g., composition, size, etc.), volumetric ratio of material to be ground and grinding medium, ball mill rotation rate, ball mill rotation duration, and any combination thereof.

Burnishing processes relate to deforming a surface due to sliding contact with another object. Examples of process control parameters that may be subject to control by the methods and systems disclosed herein include, but are not limited to, burnisher selection (e.g., shape, size, and finish, etc.), tool pressure applied, translational and/or rotational rate of burnisher relative to work piece, and any combination thereof.

Linishing processes relate to using grinding or belt sanding techniques to improve the flatness of a surface. The flatness may be two-dimensional, i.e., with the view of achieving a flat plate, or one-dimensional, e.g., with the view of achieving a perfectly cylindrical shape. Examples of process control parameters that may be subject to control by the methods and systems disclosed herein include, but are not limited to, grit selection (e.g., composition, size, etc.), tool pressure applied, translational and/or rotational rate of tool relative to the work piece, etc., and any combination thereof.

Comminution processes relate to reduction of solid materials from one average particle size to a smaller average particle size, by crushing, grinding, cutting, vibrating, or other processes. Examples of process control parameters that may be subject to control by the methods and systems disclosed herein include, but are not limited to, tool selection (e.g., size and shape of crushing rollers or jaws, grinding wheels, etc.), tool pressure applied, rotation or vibration rate of tool, etc., and any combination thereof.

Grinding processes relate to an abrasive machining process that uses a grinding wheel as the cutting tool. Examples of process control parameters that may be subject to control by the methods and systems disclosed herein include, but are not limited to, tool selection (e.g., size, shape, and coarseness of the grinding wheel), tool pressure applied, translational and/or rotational rate of tool, and any combination thereof.

Crushing processes relate to processes in which solid materials are subjected to extreme pressure to fragment the material and create smaller pieces or particles. Examples of process control parameters that may be subject to control by the methods and systems disclosed herein include, but are not limited to, tool selection (e.g., size and shape of crushing rollers or jaws), tool pressure applied, etc., and any combination thereof.

Examples of surface preparation processes include, but are not limited to, cleaning processes, sanding, smoothing, or polishing processes, painting processes, coating processes, or any combination thereof. In some embodiments, surface preparation process relates to the treating of a surface of a substance to increase its adhesion to coatings. Examples of process control parameters that may be subject to control by the methods and systems disclosed herein include, but are not limited to, cleaning agent selection (e.g., composition), sanding abrasive selection (e.g., composition, grit size, etc.), polishing compound (e.g., composition, grit size, etc.), coating selection (e.g., composition, layer thickness, etc.), and any combination thereof.

Examples of assembly processes include, but are not limited to, press fit processes, tack weld processes, thermal fit processes, riveting processes, mechanical fastener processes, or any combination thereof. Examples of process control parameters that may be subject to control by the methods and systems disclosed herein include, but are not limited to, pressure applied (e.g., in press fit or riveting assembly processes), torque applied (e.g., in mechanical fastener assembly processes), working temperature (e.g., in thermal fit processes), number of tack welds applied, etc., and any combination thereof.

Manufacturing Process Control Parameters:

Any of a variety of manufacturing process control parameters may be subject to control by the methods and systems disclosed herein, where the specific set of process control parameters to be monitored and adjusted will depend on the specific set of manufacturing processes to be performed. Examples of manufacturing process control parameters that may be subject to control by the disclosed methods and systems include, but are not limited to, temperature, pressure, vacuum, weight (e.g., of one or more components to be added to a mixture of components), volume (e.g., of one or more components to be added to a mixture of components), mixing ratios for two or more components, concentration, ionic strength, pH, volumetric flow rate, flow velocity, current, voltage, frequency, time duration, interval duration, intensity, wavelength, power, distance (e.g., between a spray nozzle and a surface), tool selection (e.g., nozzle type, cutter type, bit type, etc.), tool shape, tool dimension (e.g., cutter diameter, bit diameter, bit length, etc.), tool advancement rate, tool rotation rate, tool translation rate, tool pressure, force, clamping force, torque, tension, part rotation rate, part translation rate, heating rate, cooling rate, part orientation, and any combination thereof.

Additive Manufacturing Processes:

The term “additive manufacturing” refers to a collection of versatile fabrication techniques for rapid prototyping and manufacturing of parts that allow 3D digital models (CAD designs) to be converted to three dimensional objects by depositing multiple thin layers of material according to a series of two dimensional, cross-sectional deposition maps. Additive manufacturing may also be referred to as “direct digital manufacturing”, “solid free form fabrication”, “liquid solid free form fabrication”, or “3D printing”, and may comprise deposition of material in a variety of different states including liquid, powder, and as fused material. A wide variety of materials can be processed using additive manufacturing methods, including metals, alloys, ceramics, polymers, composites, airy structures, and multi-phase materials. One of the main advantages of additive manufacturing processes is the reduced number of fabrication steps required to transform a virtual design into a ready-to-use (or nearly ready-to-use) part. Another major advantage is the ability to process complex shapes that are not easy to fabricate using conventional machining, extrusion, or molding techniques.

Specific examples of additive manufacturing techniques to which the disclosed object defect classification and adaptive process control methods may be applied include, but are not limited to, stereolithography (SLA), digital light processing (DLP), fused deposition modeling (FDM), selective laser sintering (SLS), selective laser melting (SLM), or electronic beam melting (EBM) processes.

Stereolithography (SLA): In stereolithography, a tank of liquid ultraviolet curable resin is used in combination with a scanned laser beam to cure one thin layer of resin at a time according to a two-dimensional exposure pattern. When one layer is done, the bed or base that it was cured on is lowered slightly into the tank and another layer is cured. The build platform repeats the cycle of layer curing and downward steps until the part is complete. The amount of time required for each cycle of the process depends on the cross-sectional area of the part and the spatial resolution required. By the time that the part is complete, it is completely submerged in the uncured resin. It is then pulled from the tank and may optionally be further cured in an ultraviolet oven.

Digital light processing (DLP):Digital light processing is a variation of stereolithography in which a vat of liquid polymer is exposed to light from a DLP projector (e.g., which uses one or more digital micromirror array devices) under safelight conditions. The DLP projector projects the image of a 3D model onto the liquid polymer. The exposed liquid polymer hardens and the build plate moves down and the liquid polymer is once more exposed to light. The process is repeated until the 3D object is complete and the vat is drained of liquid, revealing the solidified model. DLP 3D printing is fast and may print objects with a higher resolution than some other techniques.

Fused deposition modeling (FDM): Fused deposition modeling is one of the most common forms of 3D printing, and is sometimes also called Fused Filament Fabrication (FFF). FDM printers can print in a variety of plastics or polymers, and typically print with a support material. FDM printers use extruder heads that super heat the input plastic filament so that it becomes a liquid, and then push the material out in a thin layer to slowly fabricate an object in a layer-by-layer process.

Selective laser sintering (SLS): Selective uses a laser to fuse material together layer by layer. A layer of powder is pushed onto the build platform and heated by a laser (and sometimes also compressed) so that it fuses without passing through a liquid state. Once that is done, another layer of powder is applied and heated again. The process requires no support material as the leftover material holds it upright. After the part is complete, one removes it from the powder bed and clean off any excess material.

Selective laser melting (SLM): Selective laser melting is a variation of selective laser sintering and direct metal laser sintering (DMLS) (Yap, et al. (2015), “Review of Selective Laser Melting: Materials and Applications”, Applied Physics Reviews 2:041101). A high power laser is used to melt and fuse metallic powders. A part is built by selectively melting and fusing powders within and between layers. The technique is a direct write technique, and has been proven to produce near net-shape parts (i.e., fabricated parts that are very close to the final (net) shape, thereby reducing the need for surface finishing and greatly reducing production costs) with up to 99.9% relative density. This enables the process to build near full density functional parts. Recent developments in the fields of fiber optics and high-powered lasers have also enabled SLM to process different metallic materials, such as copper, aluminium, and tungsten, and has opened up research opportunities in SLM of ceramic and composite materials.

Electronic beam melting (EBM): Electron beam melting is an additive manufacturing technique, similar to selective laser melting. EBM technology fabricates parts by melting metal powder layer by layer with an electron beam under high vacuum. In contrast to sintering techniques, both EBM and SLM achieve full melting of the metal powder. This powder bed method produces fully dense metal parts directly from a metal powder which have the characteristics of the target material. The EBM deposition apparatus reads data from a 3D CAD model and lays down successive layers of powdered material. These layers are melted together utilizing a computer controlled electron beam to build parts layer by layer. The process takes place under vacuum, which makes it suitable for the manufacture of parts using reactive materials with a high affinity for oxygen, e.g., titanium. The process operates at higher temperatures than many other techniques (up to 1000° C.), which can lead to differences in phase formation though solidification and solid state phase transformation. The powder feedstock is typically pre-alloyed, as opposed to being a mixture. Compared to SLM and DMLS, EBM generally has a faster build rate because of its higher energy density and scanning method.

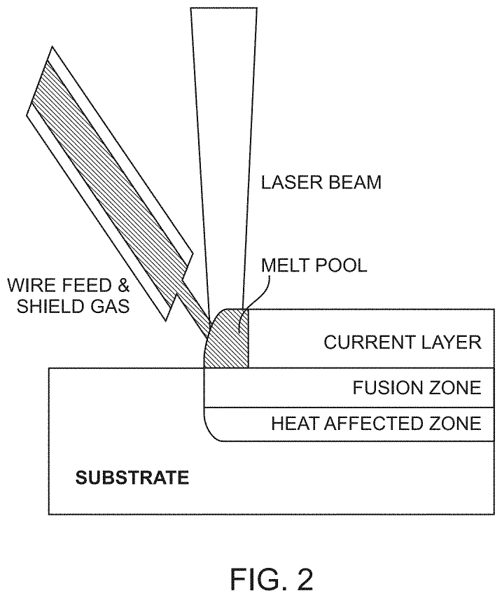

Laser-metal wire deposition: In one preferred embodiment, the additive manufacturing processes and systems to which the disclosed defect classification and adaptive control methods may be applied is laser-metal wire deposition. The central process in laser-metal wire deposition is the generation of beads of deposited material (a plurality of which may be required to form a single layer) using a high power laser source and additive material in the form of metal wire (Heralie (2012), Monitoring and Control of Robotized Laser Metal-Wire Deposition, Ph.D. Thesis, Department of Signals and Systems, Chalmers University of Technology, Goteborg, Sweden). The laser generates a melt pool on the substrate material, into which the metal wire is fed and melted, forming a metallurgical bound with the substrate. By moving the laser processing head and the wire feeder, i.e., the deposition (or welding) tool, relative to the substrate a bead is formed during solidification. The relative motion of the deposition tool and the substrate may be controlled, for example, using a 6-axis industrial robot arm. The formation of a deposited layer is illustrated in FIG. 2, as will be described in more detail below.

Prior to beginning deposition, a set of process parameters typically needs to be chosen and the equipment needs to be adjusted accordingly. Important process control parameters for laser-metal wire deposition include the laser power setting, the wire feed rate, and the traverse speed. These control the energy input, the deposition rate and the cross-section profile of the layer being deposited, i.e., the width and the height of the layer. The height (or thickness) of the deposited layer is determined by the amount of wire that is fed into the melt pool in relation to the traverse speed and the laser power. Once the nominal laser power, traverse speed, and the wire feed rate have been specified, there may be additional parameters to set, e.g., the relative orientation of the wire feed to the laser beam and substrate for a given traverse speed. Careful adjustment of these parameters is necessary in order to attain stable deposition on a flat surface.

Examples of the process control parameters that may need to be considered in order to achieve stable deposition of uniform beads of material on a flat surface include, but are not limited to:

Laser power: one of the main process control parameters, the laser power setting determines the maximum energy input. Depending on the laser beam size and the traverse speed, laser power also controls the melt pool size and consequently the width of the deposited bead.

Laser power distribution: affects the melt pool dynamics. Non-limiting examples of different laser power (or beam profile) distributions include step-function and Gaussian distributions.

Laser/wire or laser/substrate angle: affect the process window and the true energy input. The angle between the laser beam and the wire feed impacts the sensitivity of the deposition process to changes in wire feed rate and variations in distance between the wire nozzle and the substrate. The angle between the laser beam and the substrate impacts the reflection of the laser beam from the substrate surface, and hence the amount of absorbed energy.

Laser beam size and shape: control the size and the shape of the melt pool (together with the laser power and the traverse speed). The use of a circular beam shape is common, although rectangular shapes are being used as well (e.g., with diode lasers). The size is chosen to reflect the desired bead width.

Laser beam focal length: controls how collimated the laser beam is at the substrate surface. Consequently, it impacts the sensitivity of the deposition process to distance variations between the focus lens and the substrate.

Laser wavelength: controls the absorbance of the laser beam by the deposited material. For metals, the absorbance of laser light varies with wavelength (and specific materials).

Wire feed rate: another one of the main process control parameters, the wire feed rate impacts the amount of mass deposited per unit time. The wire feed rate primarily impacts the bead height, and needs to be chosen in relation to the laser power and the traverse speed.

Wire diameter: should be chosen in relation to the laser beam size to ensure proper melting and a flexible process.

Wire/substrate angle: affects the melting of the wire and thereby also the stability of the deposition process. Under proper conditions, the transfer of metal between the wire and the melt pool is smooth and continuous. Use of an improper wire/substrate angle may cause the metal transfer process to result in either globular deposition, e.g., as a series of droplets on the substrate surface, or the wire may still be solid as it enters the melt pool. Use of a higher angle reduces sensitivity to deposition direction, but at the same time results in a smaller process window of allowable wire feed rates.

Wire tip position relative to the melt pool: also affects the melting rate of the wire and thereby the stability of the process.

Wire stick-out: typically not as critical as the wire angle or the wire tip position, but the stick-out distance may need to be adjusted depending on the expected deposition conditions. It primarily affects the sensitivity of the process to variations in height between the wire nozzle and the substrate.

Shield gas: use of a shield gas may impact the degree to which contaminants and/or defects are introduced into the deposition layer. Composition, flow rate, and/or angle of incidence may be adjusted in some embodiments.

Feed direction: determines from which direction the wire enters the melt pool, and thereby affects the melting of the wire, and thus the metal transfer process. Different choices of feed direction change the range of allowed wire feed rates that may be used. In some cases it can also affect the shape of the deposited bead.

Traverse speed: another one of the main process control parameters, the traverse speed impacts the amount of material deposited per unit length and the input energy per unit length. At lower traverse speeds the deposition process is typically more stable, unless the temperature of the deposited material becomes too high. At high traverse speeds, lower energy inputs can be obtained for the same amount of material deposited per unit length. However, the motion control system's acceleration and path accuracy become more critical.

Process stability: Proper tuning of the process control parameters described above influences the rate of transfer of metal between the solid wire and the melt pool, which is important for the stability of the deposition process. In general, there are three ways that the metal wire can be deposited: by globular (droplet-like) transfer, smooth transfer, or by plunging (i.e., incomplete melting of the wire prior to entering the melt pool). Only smooth transfer results in a stable deposition process.

If the deposition apparatus is set-up so that the wire tip spends too much time in the laser beam (e.g., by choosing a feed angle that is too high in relation to the other process control parameters), it will reach the melting temperature somewhere prior to entering the melt pool. The transfer of metal between the solid wire and the melt pool might then be stretched to a point where surface tension can no longer maintain the flow of metal, resulting in the formation and separation of surface tension-induced spherical droplets. This type of deposition gives rise to highly irregular bead shapes and a poor deposition process. Once globular transfer starts, it is typically hard to abort. The physical contact between the molten wire tip and the melt pool must be re-established, and the process control parameters must be adjusted to appropriate values.

Alternatively, if the wire feed angle is carefully adjusted so that the wire is melted close to the intersection with the melt pool, there will be a smooth transfer of metal from the solid wire to the liquid metal of the melt pool. The resulting beads of deposited metal will have a smooth surface and a stable metallurgical bond to the substrate.

Another way to melt the wire is by heat conduction from the melt pool, i.e., by plunging the wire into the melt pool. Precautions must be taken to adjust the wire feed rate to a value sufficiently low relative to the melting rate provided by the heat energy in the melt pool that the wire melts completely. Incomplete melting can result in, for example, lack of fusion (LOF) defects. Note that LOF defects may occur even at low wire feed rates for which the resulting beads are more or less indistinguishable from normal bead depositions.

Adjustment of process parameters: The process control parameters described above are adjusted depending on the choice of material and the energy input required to melt the material, which in turn is determined based on the desired deposition rate, deformation restrictions, the material's viscosity, and the available laser power and beam spot sizes. These factors put a requirement on the laser power, the traverse speed, and the wire feed rate settings. The laser beam should preferably be as orthogonal to the melt pool as possible to minimize reflection while avoiding back reflection into the optical system. The wire tip position relative to the melt pool should be adjusted with regard to the chosen amount of material deposited per time unit. If a front feed configuration is used and the deposition rate is low, the wire should enter the melt pool closer to the leading edge. Changing this parameter mainly affects the maximum and minimum wire feed rate for the chosen laser power and traverse speed. A closely related parameter to the wire tip position is the wire/substrate angle. If the angle is low, high wire feed rates might be possible since plunging can be exploited in a better way. However, for extreme wire feed rates, only front feeding is feasible. This then limits the choice of complex deposition paths, such as zig-zag or spiral patterns. To decrease the sensitivity of the deposition process to feed direction and thereby allow for arbitrary deposition patterns, the angle between the wire and the substrate should be increased. However, increased flexibility in terms of allowable deposition patterns is often achieved at the cost of a smaller process window.

Multi-layered deposition: Obtaining stable deposition of a single bead of material on a flat substrate requires careful adjustment of the process control parameters, as discussed above. Ultimately, however, the goal is to deposit three-dimensional parts, i.e., to deposit several adjacent beads in a layer, and to repeat the deposition for a number of layers. The transition from deposition of a single bead to deposition of a three-dimensional part is often not straightforward. The precise shape of the individual layers are influenced by several additional factors, e.g., the deposition pattern, the distance between adjacent beads, and the motion control system's speed and path accuracy. The relationship between these factors and their impact of the resulting layer are complex and hard to predict, which complicates the adjustment of process control parameters required to achieve a given deposition design feature, e.g., the layer height. Another example of a factor that complicates the deposition of three-dimensional parts is the potential increase in local temperature of the part due to heat accumulation, which needs to be considered during multi-layered deposition. Heat may be accumulated in the deposited part, for example, due to the use of overly short pauses between deposition of adjacent layers.

The additional uncertainties that arise in three-dimensional deposition may create a problem from a process stability point of view. For example, if the estimate of layer height to be achieved is incorrect, the relationship between the wire tip and the substrate will be different from what was expected for the process parameters as originally set. As a result, the deposition process might transition from a smooth transfer of the molten wire to either a globular deposition mode or a wire plunging mode. Consequently, as long as the deposition process is not sufficiently understood and/or tightly controlled that the dimensions of the individual layers can be accurately predicted, three-dimensional deposition may require continuous on-line monitoring and/or process control parameter adjustment.

Difficulties in Optimizing Additive Manufacturing Processes:

Some of the difficulties discussed above in the context of laser-metal wire deposition are also applicable to other additive manufacturing processes (Guessasma, et al., (2015) “Challenges of Additive Manufacturing Technologies from an Optimisation Perspective”, Int. J. Simul. Multisci. Des. Optim. 6, A9). Generation of the toolpaths from three-dimensional CAD models represents the first challenge. Most additive manufacturing technologies rely on a successive layer-by-layer fabrication process, so starting from a three-dimensional representation of the part (i.e., a tessellated version of the part's actual surface) and ending with a two-dimensional build strategy may introduce errors. The problem is particularly prevalent in droplet-based 3D printing approaches, as discontinuities in the fused material may appear in all build directions as a result of the layer-by-layer deposition process, and may lead to dimensional inaccuracy, unacceptable finish state, and structural and mechanical anisotropies. Anisotropy may also arise in the development of particular grain texture, for example, in laser melting deposition or arc welding of metals. Reduction of anisotropy may sometimes be achieved by selecting the appropriate build orientation of the virtual design.

In addition, the differences between a virtual design and the as-fabricated object may sometimes be significant due to the finite spatial resolution available with the additive manufacturing tooling used, or due to part shrinkage during solidification of the deposited material, which can cause both changes in dimension as well as deformation of the part. Consider, for example, fused deposition modelling for which the toolpath comprises a collection of filament paths of finite dimension. This has three main consequences on the fabricated object: (i) internal structural features may not be well captured depending on their size; (ii) discontinuities may appear depending on local curvature; and (iii) the surface finish state may be limited due to rough profiles arising from the fusing of multiple filaments.

One consequence of the discontinuous fabrication process and other issues related to additive manufacturing process errors is porosity. Many technical publications have been directed to the evaluation of the effect of porosity in printed parts. One particular consequence is that porosity may reduce the mechanical performance of the part, e.g., through a decrease of stiffness with increased porosity level, or through lower mechanical strength under tension because of the development of porosity-enhanced damage in the form of micro-cracks. It should be noted that porosity may not always be viewed as a negative consequence of additive manufacturing processes, as it can be used, for example, to increase permeability in some applications.

Another type of defect encountered with some additive manufacturing processes is the presence of support material trapped between internal surfaces. Support material is sometimes needed to reinforce fragile printed structures during the printing process. Although these materials are typically selected to exhibit limited adhesion to the deposited materials, incomplete removal resulting in residual amounts of support material in the part may contribute to, for example, increased weight of the part and a modified load bearing distribution, which in turn may alter the performance of the part relative to that expected based on the original design. In addition, non-optimized support deposition may affect the finish state of the part, material consumption, fabrication time, etc. Various strategies have been described in the literature to reduce the dependence of additive manufacturing processes on the use of support materials. The strategies may vary depending on the geometry of the part and the choice of material to be deposited.

Welding Processes:

In some embodiments, the disclosed defect classification and process control methods and systems may be applied to welding processes and apparatus instead of, or in combination with, additive manufacturing processes and apparatus. Examples of welding processes and apparatus that may be employed with the disclosed process control methods and systems include, but are not limited to, laser beam welding processes and apparatus, MIG (metal inert gas) welding processes and apparatus (also referred to as gas metal arc welding), TIG (tungsten inert gas) welding processes and apparatus, and the like.

Laser beam welding (LBW): a welding technique used to join metal components that need to be joined with high welding speeds, thin and small weld seams and low thermal distortion. The laser beam provides a focused heat source, allowing for narrow, deep welds and high welding rates. The high welding speeds, automated operation, and capability to implement feedback control of weld quality during the process make laser welding a common joining method in modern industrial production. Examples of automated, high volume applications include use in the automotive industry for welding car bodies. Other applications include the welding of fine, non-porous seams in medical technology, precision spot welding in the electronics or jewelry industries, and welding in tool and mold-making.

MIG welding: an arc welding process in which a continuous solid wire electrode is fed through a welding gun and into the weld pool, joining the two base materials together. A shielding gas is also sent through the welding gun and protects the weld pool from contamination, hence the name “metal inert gas” (MIG) welding. MIG welding is typically used to join thin to medium thick sheets of metal.

TIG welding: TIG welding (technically called gas tungsten arc welding (GTAW)) is a process that uses a non-consumable tungsten electrode to deliver the current to the welding arc. The tungsten and weld puddle are protected and cooled with an inert gas, typically argon. TIG welding typically produces a somewhat neater and more controlled weld than MIG welding.

Conversion of 3D CAD Files to Layers and Tool Paths:

Computer-aided design: The first step in a typical free form deposition process, such as an additive manufacturing process, is to create a three dimensional model of the object to be fabricated using a computer-aided design (CAD) software package. Any of a variety of commercially-available CAD software packages may be used including, but not limited to, SolidWorks (Dassault Systémes SolidWorks Corporation, Waltham, Mass.), Autodesk Fusion 360 (Autodesk, Inc., San Rafael, Calif.), Autodesk Inventor (Autodesk, Inc., San Rafael, Calif.), PTC Creo Parametric (Needham, Mass.), and the like.

Conversion to STL file format: Once the CAD model is completed, it is typically converted to the standard STL (stereolithography) file format (also known as the “standard triangle language” or “standard tessellation language” file format) that was originally developed by 3D Systems (Rock Hill, S.C.). This file format is supported by many other software packages and is widely used for rapid prototyping, 3D printing, and computer-aided manufacturing. STL files describe only the surface geometry of a three-dimensional object without any representation of color, texture or other common CAD model attributes. In an ASCII STL file, the CAD model is represented using triangular facets, which are described by the x-, y-, and z-coordinates of the three vertices (ordered according to the right-hand rule) and a unit vector to indicate the normal direction that points outside of the facet (Ding, et al. (2016), “Advanced Design for Additive Manufacturing: 3D Slicing and 2D Path Planning”, Chapter lin New Trends in 3D Printing, I. Shishkovsky, Ed., Intech Open).

Slicing the STL model to create layers: Once the STL file has been created unidirectional or multidirectional slicing algorithms are used to slice the STL model into a series of layers according to the build direction. Uniform slicing methods create layers having a constant thickness. The accuracy of additively manufactured parts may sometimes be improved by altering the layer thickness. Typically, the smaller the layer thickness, the higher the achieved accuracy will be. The material deposition rate is also highly relevant to the sliced layer thickness. Adaptive slicing approaches thus slice the STL model with a variable thickness. Based on the surface geometry of the model, this approach automatically adjusts the layer thickness to improve the accuracy of the fabricated part or to improve the build time.

As noted above, many additive manufacturing processes utilize slicing a 3D CAD model into a set of two-dimensional layers having either a constant or adaptive thickness, where the layers are stacked in a single build direction. However, when fabricating parts with complex shapes unidirectional slicing strategies are generally limited by the need to include support structures for fabrication of overhanging features. The need to deposit support structures results in longer build times, increased material waste, and increased (and sometimes costly) post-processing for the removal of the supports. Some additive manufacturing techniques are capable of depositing material along multiple build directions. The use of multi-directional deposition helps to eliminate or significantly decrease the requirement for support structures in the fabrication of complex objects. A key challenge in multi-directional additive manufacturing is to develop robust algorithms capable of automatically slicing any 3D model into a set of layers which satisfy the requirements of support-less and collision-free layered deposition. A number of strategies for achieving this have been described in the technical literature (Ding, et al. (2016), “Advanced Design for Additive Manufacturing: 3D Slicing and 2D Path Planning”, Chapter lin New Trends in 3D Printing, I. Shishkovsky, Ed., Intech Open).

Tool path planning: Another important step in free form deposition or additive manufacturing is the development of tool path strategies based on the layers identified by the slicing algorithm. Tool path planning for powder-based additive manufacturing processes that utilize fine, statistically-distributed particles is somewhat independent of geometric complexity. However, tool path planning for additive manufacturing processes that utilize larger, sometimes coarse beads of deposited material may be directly influenced by geometric complexity. In addition, the properties of the deposited material (height and width of the bead, surface finish, etc.) may be influenced by the deposition tool path trajectory. A variety of tool path planning strategies have been described in the technical literature including, but not limited to, the use of raster tool paths, zigzag tool paths, contour tool paths, tool paths, hybrid tool paths, continuous tool paths, hybrid and continuous tool paths, medial axis transformation (MAT) tool paths, and adaptive MAT tool paths.

Raster tool paths: The raster scanning tool path technique is based on planar ray casting along one direction. Using this tool path approach, two-dimensional regions of a given layer are filled in by depositing a set of material beads having finite width. Commonly employed in commercial additive manufacturing systems, it features simple implementation and is suitable for use with almost any arbitrary boundary.

Zigzag tool paths: Derived from the raster approach, zigzag tool path generation is the most popular method used in commercial additive manufacturing systems. Compared to the raster approach, the zigzag approach significantly reduces the number of tool path passes (and hence the build time) required to fill in the geometry line-by-line by combining the separate parallel lines into a single continuous zigzag pass. As with the raster tool path approach, the outline accuracy of the part is sometimes poor due to discretization errors on any edge that is not parallel to the tool motion direction.

Contour tool paths: Contour tool paths, another frequently used tool path method, help address the geometrical outline accuracy issue noted above by following the part's boundary contours. Various contour map patterns have been described in the literature for developing optimal tool path patterns for parts comprising primarily convex shapes that may also include openings or ‘islands” (isolated sections of a model within a given layer).

Spiral tool paths: Spiral tool paths have been widely applied in computer numerically controlled (CNC) machining, e.g., for two-dimensional pocket milling (i.e., removal of material inside of an arbitrarily closed boundary on a flat surface of a work piece to a specified depth). This method can also be used with additive manufacturing processes to overcome the boundary problems of zigzag tool paths, but is typically only suitable for certain special geometrical models.

Hybrid tool paths: Hybrid tool paths share some of the features of more than one approach. For example, a combination of contour and zigzag tool path patterns is sometimes developed to meet both the geometrical accuracy requirements of a part and to improve the overall build efficiency.

Continuous tool paths: The goal of continuous tool path approaches is to fill in a deposition layer using one continuous path, i.e., a tool path that is capable of filling in an entire region without intersecting itself. This approach has been found to be particularly useful in reducing shrinkage during some additive manufacturing fabrication processes. However, the approach often necessitates frequent changes in path direction that may not be suitable for some deposition processes. Furthermore, when the area to be filled is large and the accuracy requirement is high, the processing time required may be unacceptably long. In addition, highly convoluted tool paths may result in excess accumulation of heat in certain regions of the part, thereby inducing unacceptable distortion of the part.

Hybrid continuous tool paths: Tool path strategies have been developed which combine the merits of zigzag and continuous tool path patterns. In these approaches, the two-dimensional geometry is first decomposed into a set of monotone polygons. For each monotone polygon, a closed zigzag curve is then generated. Finally, a set of closed zigzag curves are combined together into an integrated continuous tortuous path. Recently, another continuous path pattern which combines the advantages of zigzag, contour, and continuous tool path patterns has been developed.

Medial axis transformation (MAT) tool paths: An alternative methodology for generating tool paths uses the medial axis transformation (MAT) of the part geometry to generate offset curves by starting at the inside and working toward the outside, instead of starting from the layer boundary and filling toward the inside. The medial axis of an object is the set of all points having more than one closest point on the object's boundary. In two dimensions, for example, the medial axis of a subset S of circles which are bounded by planar curve C is the locus of the centers of all circles within S that tangentially intersect with curve C at two or more points. The medial axis of a simple polygon is a tree-like skeleton whose branches are the vertices of the polygon. The medial axis together with an associated radius function of maximally inscribed circles is called the medial axis transform (MAT). The medial axis transform is a complete shape descriptor that can be used to reconstruct the shape of the original domain.

This approach is useful for computing tool paths which can entirely fill the interior region of the layer geometry, and avoids producing gaps by depositing excess material outside the boundary which can subsequently be removed through post-processing. Traditional contour tool path patterns which run from outside to inside are often used for machining, whereas MAT tool paths starting from the inside and working toward the outside are often more suitable for additive manufacture of void-free parts. The main steps for generating MAT-based tool paths are: (i) computation of the medial axis; (ii) decomposition of the geometry into one or more regions or domains, where each domain is bounded by a portion of the medial axis and a boundary loop; (iii) generation of the tool path for each domain by offsetting from the medial axis loop toward the corresponding boundary loop with an appropriate step-over distance. The offsetting is repeated until the domain is fully covered; and (iv) repeating step (iii) for each domain to generate a set of closed-loop paths, preferably without start/stop sequences. MAT path planning is frequently used, for example, with arc welding systems, and is particularly preferred for void-free additive manufacturing.

Adaptive MAT tool paths: Traditional contour tool paths frequently generate gaps or voids. MAT tool path planning was introduced to avoid generation of internal voids during deposition, and has been extended to handle complex geometries. As noted above, MAT tool paths are generated by offsetting the medial axis of the geometry from the center toward the layer boundary. Although MAT tool paths reduce the occurrence of internal voids, this is achieved at the cost of creating path discontinuities and extra material deposition at the layer boundary. Post-process machining to remove the extra materials and improve the dimensional accuracy of the part requires extra time and adds to the cost. For both traditional contour tool paths and MAT tool paths, the step-over distance, i.e., the distance between the next deposition path and the previous deposition path, is held constant. For some part geometries, it is not possible to achieve both high dimensional accuracy and void-free deposition using tool paths with constant step-over distance. However, some additive manufacturing processes, such as wire feed additive manufacturing processes, are capable of producing different deposited bead widths within a layer by varying process control parameters like travel speed and wire feed rate, while maintaining constant deposition height. Adaptive MAT tool path planning uses continuously varying step-over distances by adjusting the process parameters to deposit beads with variable width within a given tool path. Adaptive MAT path planning algorithms are able to automatically generate path patterns with varying step-over distances by analyzing the part geometry to achieve better part quality (void-free deposition), accuracy at the boundary, and efficient use of material.

Tool path generation software: Examples of toolpath generation software include Repetier (Hot-World, GmbH, Germany) and CatalystEx (Stratasys Inc. Eden Prairie Minn., USA).

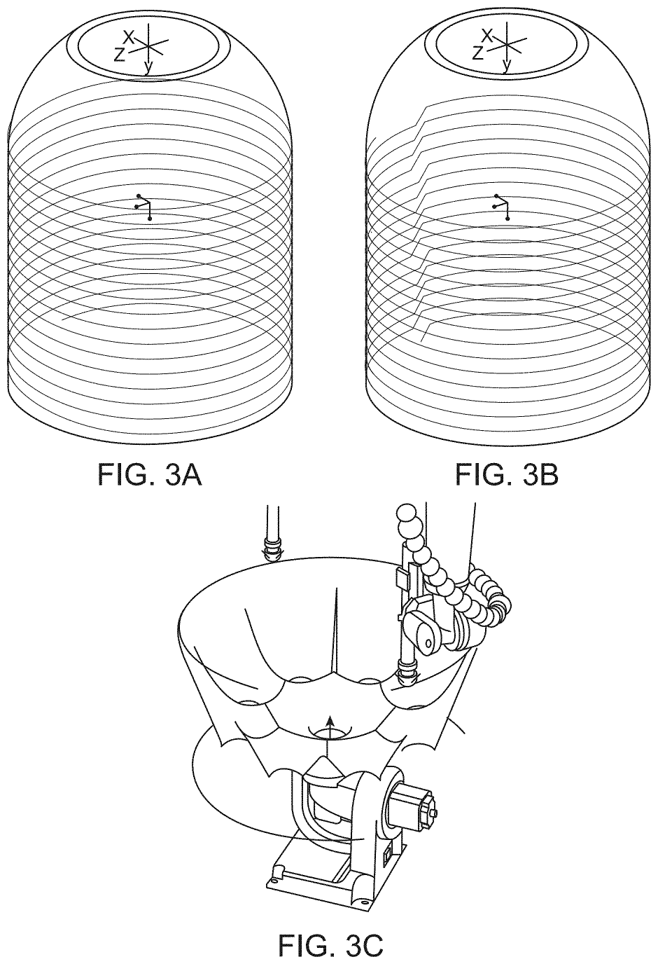

FIGS. 3A-C provide schematic illustrations of the conversion of a CAD design for a three-dimensional object to a continuous, spiral wound “two-dimensional” layer (of finite thickness) and associated helical tool path (FIG. 3A), or a stacked series of “two-dimensional” layers and associated circular, layer-by-layer tool paths (FIG. 3B) for deposition of material using an additive manufacturing process. FIG. 3C provides an illustration of the tool path for a robotically manipulated deposition tool and a simulation of the resulting object fabricated using an additive manufacturing process. Tool path and part simulation using a software package such as Octopuz (Jupiter, Fla.) is performed before running the deposition process on an actual deposition system. In some instances, the predicted optimal tool path may be locally modified during the deposition process in response to closed-loop feedback control. In some instances, the tool path may be reconstructed based on the as-built part geometry after the deposition process is complete.

Process Simulation Tools:

In some embodiments of the disclosed adaptive process control methods and systems, process simulation tools may be used to simulate the manufacturing process, e.g., an injection molding process, a free form deposition process, or joining process, and/or to provide estimates of optimal starting sets (and/or sequences) of process control parameter settings (and adjustments). Any of a variety of process simulation tools known to those of skill in the art may be used including, but not limited to finite element analysis (FEA), finite volume analysis (FVA), finite difference analysis (FDA), computational fluid dynamics (CFD), and the like, or any combination thereof. In some embodiments of the disclosed methods and system, process simulation data from past manufacturing runs is used as part of a training data set used to “teach” the machine learning algorithm used to run the process control.

Finite element analysis (FEA): Finite element analysis (also referred to as the finite element method (FEM)) is a numerical method for solving engineering and mathematical physics problems, e.g., for use in structural analysis, or studies of heat transfer, fluid flow, mass transport, and electromagnetic potential. Analytical solution of these types of problems generally requires the solution to boundary value problems involving partial differential equations, which may or may not solvable. The computerized finite element approach allows one to formulate the problem as a system of algebraic equations, the solution for which yields approximate values of the unknown parameters at a discrete number of points over the geometry or domain of interest. The problem to be solved is subdivided (discretized) into smaller, simpler components (i.e., the finite elements) to simplify the equations governing the behavior of the system. The relatively simple equations that model the individual finite elements are then assembled into a larger system of equations that models the entire problem. Numerical methods drawn from the calculus of variations are used to approximate a solution to the system of equations by minimizing an associated error function. FEA is often used for predicting how a product will react when subjected to real-world forces, e.g., stress (force per unit are or per unit length), vibration, heat, fluid flow, or other physical effects.

As noted above, in some embodiments of the disclosed adaptive process control methods, FEA may be used to simulate a manufacturing process and/or to provide estimates of optimal starting sets and/or sequences of process control parameter settings and adjustments thereof. For instance, examples of deposition process parameters that may be estimated using FEA analysis (or other simulation techniques) include, but are not limited to, a prediction of a bulk or peak temperature of a deposited material, a cooling rate of a deposited material, a chemical composition of a deposited material, a segregation state of constituents in a deposited material, a geometrical property of a deposited material, an angle of overhang in a deposited geometry, an intensity of heat flux out of a material during deposition, an electromagnetic emission from a deposition material, an acoustic emission from a deposition material, or any combination thereof, as a function of a set of specified input process control parameters.

Because the process control parameters used as input for the calculation may be adjusted to determine how they impact the simulated deposition process, iterative use of process simulation may be used to provide estimates of optimal sets and/or sequences of process control parameter settings and adjustments thereof.

Finite volume analysis (FVA): Finite volume analysis (also referred to as the finite volume method (FVM)) is another numerical technique related to finite element analysis that is used for solving partial differential equations, especially those that arise from physical conservation laws. FVM uses a volume integral formulation of the problem with a finite set of partitioning volumes to discretize the equations representing the original problem. FVA is, for example, commonly used for discretizing computational fluid dynamics equations.

Finite difference analysis (FDA): Finite difference analysis (also referred to as the finite difference method (FDM)) is another numerical method for solving differential equations by approximating them with difference equations, in which finite differences approximate the derivatives.

Computational fluid dynamics (CFD): Computational fluid dynamics refers to the use of applied mathematics, physics, and computational software (e.g. finite volume analysis software) to visualize how a gas or liquid flows in response to applied pressure, or to visualize how the gas or liquid affects objects as it flows past. Computational fluid dynamics is based on solution of Navier-Stokes equations, which describe how the velocity, pressure, temperature, and density of a moving fluid are related. CFD-based analysis is used in a variety of industries and applications, for example, computational fluid dynamics has been used to model predictive control for controlling melt temperature in plastic injection molding.

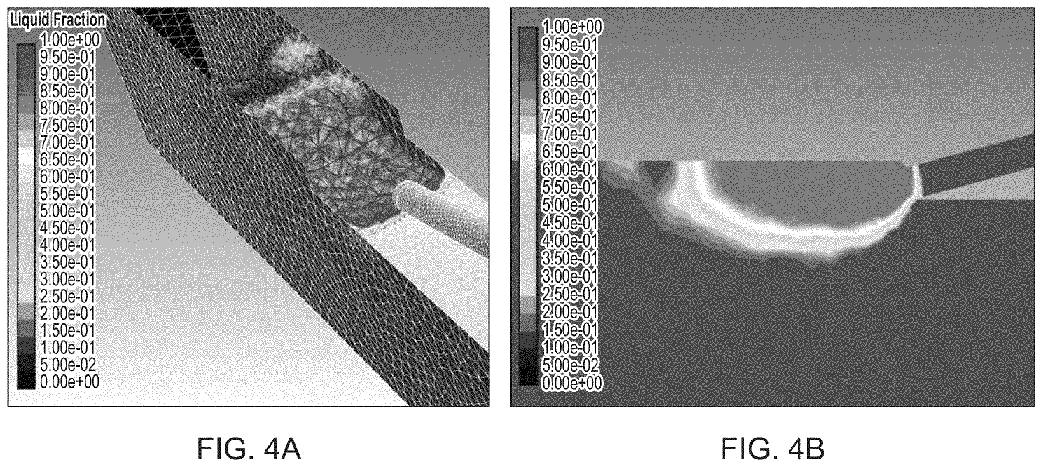

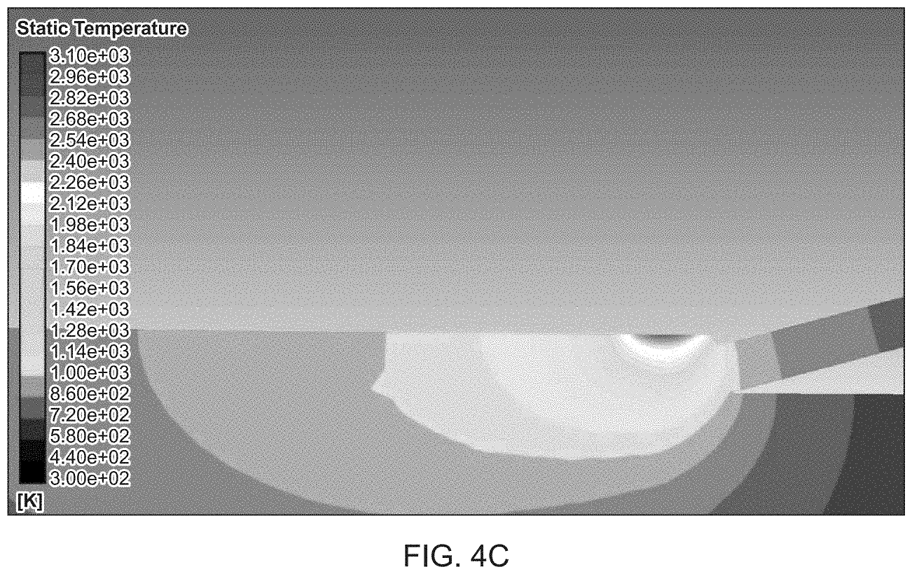

FIGS. 4A-C provide examples of FEA simulation data for modeling of a laser-metal wire deposition melt pool. FIG. 4A: isometric view of color-encoded three dimensional FEA simulation data for the liquid fraction of material in the melt pool being deposited by a laser-metal wire deposition process. The metal is in a completely liquid state at the position where the wire tip merges with the melt pool, and transitions to increasingly lower liquid fractions as it solidifies downstream from the position of the wire. FIG. 4B: cross-sectional view of the FEA simulation data for the liquid fraction of material in the melt pool. FIG. 4C: cross-sectional view of color-encoded three dimensional FEA simulation data for the static temperature of the material in the melt pool. The temperature is at a maximum value (approximately 2,900° K in this example) at the point where the laser beam impinges on the wire tip, and is asymmetrically distributed along the motion path of the deposition apparatus with higher temperatures exhibited by the material immediately downstream from the wire tip.

Process Control Parameters:

In some embodiments of the disclosed adaptive process control methods, one or more manufacturing process control parameters may be set and/or adjusted in real-time through the use of a machine learning algorithm that processes real-time manufacturing process monitoring data, e.g., data from a machine vision system or laser interferometry measurement system, and uses that information to adjust the one or more process control parameters to improve the efficiency of the process and/or the quality of the part being fabricated or assembled.

In general, the types of process control parameters that may be set and/or adjusted by the adaptive process control system will vary depending on the specific type of manufacturing process being used. For instance, examples of process control parameters that may be set and/or adjusted for a free form deposition or additive manufacturing process include, but are not limited to, the rate of material deposition, the rate of displacement for a deposition apparatus, the rate of acceleration for a deposition apparatus, the direction of displacement for a deposition apparatus, the location of a deposition apparatus as a function of time (i.e., a tool path), the angle of a deposition apparatus with respect to a deposition direction, the angle of overhang in an intended geometry, the intensity of heat flux into a material during deposition, the size and shape of a heat flux surface, the flow rate and angle of a shielding gas flow, the temperature of a baseplate on which material is deposited, the ambient temperature during a deposition process, the temperature of a deposition material prior to deposition, a current or voltage setting in a resistive heating apparatus, a voltage frequency or amplitude in an inductive heating apparatus, the choice of deposition material, the ratio by volume or the ratio by weight of deposition materials if more than one deposition material is used, or any combination thereof.

As indicated above, examples of process control parameters for a laser-metal wire deposition process that may be set and/or adjusted by the adaptive process control systems of the present disclosure include, but are not limited to, laser power, laser power distribution (or beam profile), laser/wire or laser/substrate angle, laser beam size and shape, laser beam focal length, laser wavelength, wire feed rate, wire diameter, wire/substrate angle, wire tip position relative to the melt pool, wire stick-out, shield gas settings, feed direction, and traverse speed.

In some embodiments of the disclosed adaptive process control methods and system, one or more process control parameters may be set and/or adjusted by the machine learning algorithm used to run the control process. In some embodiments, the number of different process control parameters to be set and/or adjusted may be at least 1, at least 2, at least 3, at least 4, at least 5, at least 10, at least 15, or at least 20. Those of skill in the art will recognize that the number of different process control parameters to be set and/or adjusted by the disclosed process control methods and systems may have any value within this range, e.g., 12 process control parameters.

Process Monitoring Tools:

In some embodiments of the disclosed adaptive manufacturing process control methods and systems, one or more process monitoring tools may be used to provide real-time data on process parameters or properties of the object being fabricated, both of which will be referred to herein as “process characterization data”. In some embodiments of the disclosed methods and system, process characterization data from past manufacturing process runs is used as part of a training data set used to “teach” the machine learning algorithm used to run the process control. In some embodiments, real-time (or “in-process”) process characterization data is fed to the machine learning algorithm so that it may adaptively adjust one or more process control parameters in real-time.

Any of a variety of process monitoring tools known to those of skill in the art may be used including, but not limited to, temperature sensors, position sensors, motion sensors, touch/proximity sensors, accelerometers, profilometers, goniometers, image sensors and machine vision systems, electrical conductivity sensors, thermal conductivity sensors, strain gauges, durometers, X-ray diffraction or imaging devices, CT scanning devices, ultrasonic imaging devices, Eddy current sensor arrays, thermographs, deposition apparatus status indicators, or any combination thereof. In some embodiments, the process characterization sensors may comprise one or more sensors, cameras, or imaging systems that detect electromagnetic radiation that is reflected, scattered, absorbed, transmitted, or emitted by the object. In some embodiments, the process characterization sensors may comprise one or more sensors that provide data on acoustic energy or mechanical energy that is reflected, scattered, absorbed, transmitted, or emitted by the object.

Any of a variety of process parameters may be monitored (i.e., to generate process characterization data) using appropriate sensors, measurement tools, and/or machine vision systems. For instance, in the case of a free form deposition or additive manufacturing process, process parameters that may be monitored include, but not limited to, measurement of a bulk or peak temperature of a deposited material, a cooling rate of a deposited material, a chemical composition of a deposited material, a segregation state of constituents in a deposited material, a geometrical property of a deposited material (e.g., a local curvature of a printed part), a rate of material deposition, a rate of displacement for a deposition apparatus, a location (tool path) of a deposition apparatus, an angle of a deposition apparatus with respect to a deposition direction, a deposition apparatus status indicator, an angle of overhang in a deposited geometry, an angle of overhang in an intended geometry, an intensity of heat flux into a material during deposition, an intensity of heat flux out of a material during deposition, an electromagnetic emission from a deposition material, an acoustic emission from a deposition material, an electrical conductivity of a deposition material, a thermal conductivity of a deposition material, a defect in the geometry of an object being fabricated, or any combination thereof.

Additional examples of process monitoring and inspection processes include, but are not limited to, non-destructive inspection processes, ultrasonic inspection processes, eddy current inspection processes, X-radiography processes (e.g., CT scan processes), dye penetrant processes, magnetic penetrant processes, acoustic emission processes, or any combination thereof. In some cases, an inspection process may be a non-destructive inspection processes related to analysis techniques used in science and technology industry to evaluate the properties of a material, component or system without causing damage to the material, component, or system.

Ultrasonic inspection processes relate to the use of sound waves to detect cracks and defects in parts and materials. In some embodiments, it can be used to determine a material's thickness, such as measuring the wall thickness of a pipe.

Eddy current inspection processes relate to the use of electromagnetic induction to detect and characterize surface and sub-surface flaws in conductive materials.

X-radiography processes (e.g., CT scan processes) may be used to determine a part or component's internal structure.

Dye penetrant processes relate to a process of locating surface-breaking defects in non-porous materials.

Magnetic penetrant processes relates to a process for detecting surface and shallow subsurface discontinuities in ferromagnetic materials. In some embodiments, the process comprises subjecting the part to a magnetic field.

Acoustic emission processes are used to study the formation of cracks during the welding process and relates to the use of the radiation of acoustic or elastic waves in solids that may occur when a material undergoes irreversible changes in its internal structure.

The disclosed methods and systems for adaptive process control may comprise the use of any number and any combination of sensors or process monitoring tools and techniques. For example, in some embodiments, a manufacturing process control system of the present disclosure may comprise at least 1, at least 2, at least 3, at least 4, at least 5, at least 6, at least 7, at least 8, at least 9, or at least 10 sensors or process monitoring tools. In some embodiments, the one or more sensors or process monitoring tools may provide data to the process control algorithm at an update rate of at least 0.1 Hz, 1 Hz, 5 Hz, 10 Hz, 20 Hz, 30 Hz, 40 Hz, 50 Hz, 60 Hz, 70 Hz, 80 Hz, 90 Hz, 100 HZ, 250 Hz, 500 Hz, 750 Hz, 1,000 Hz, 2,500 Hz, 5,000 Hz, 10,000 Hz, or higher. Those of skill in the art will recognize that the one or more sensors or process monitoring tools may provide data at an update rate having any value within this range, e.g., about 225 Hz.

Laser interferometry: One specific example of a manufacturing process monitoring tool that may be used with, for example, a laser-metal wire deposition system is a laser interferometer for accurate, in-process measurement of part dimensions, refractive index changes, and/or surface irregularities. Laser light from a single source is split into two beams that follow separate optical paths until they are re-combined following the transmission or reflection of one of the beams by a sample, e.g., the part being fabricated, to produce interference. The resulting interference fringes provide precise information about the difference in optical path length for the two beams, and hence provide precise measurements of part dimensions, displacements, surface irregularities, etc. Interferometers are capable of measuring dimensions or displacements with nanometer precision.

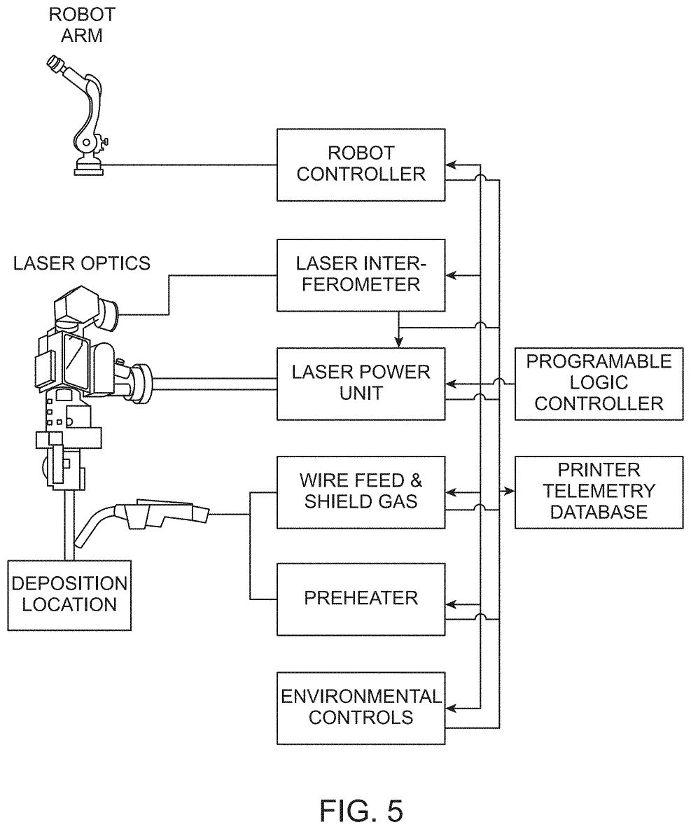

FIG. 5 illustrates one non-limiting example of a laser-metal wire deposition system that comprises a robotic controller, a laser power unit, a wire feed and shield gas module, a wire pre-heater, and environmental controller, a telemetry database (for transmitting and recording process control instructions sent to and process monitoring data read from the deposition system), and a programmable logic controller (which coordinates the overall operation of the system components), as well as a laser interferometer. The laser interferometer provides real-time feedback on melt pool properties. In some embodiments, the deposition system may further comprise a processor programmer to utilize a machine learning algorithm, e.g., an artificial neural network, for real-time, adaptive control of the metal deposition process. In some embodiments, the deposition system may also include machine vision systems or other inspection tools monitor process parameters and/or to provide for automated classification of object defects (post-build or in-process), and may incorporate such process monitoring or defect classification for use by the machine algorithm in predicting next action(s) by the deposition process.

FIG. 2 provides a schematic illustration of an example set-up for a material deposition process, e.g., a laser-metal wire deposition process, according to some embodiments of the present disclosure. The laser beam impinges on the metal wire to create a melt pool at the point of intersection and deposit material on a substrate. The melt pool material subsequently hardens to form a new layer as the laser and wire feed (i.e. the print head) are moved relative to the substrate. The wire is shielded from air-borne contaminants with the use of a sheath of shield gas. As indicated by the example of FEA simulation date presented in FIG. 4C, heat propagates from the position of the melt pool through the underlying substrate (or previously deposited layers) in an asymmetric fashion due to the translational motion of the print head relative to the substrate. The newly deposited layer forms a metallurgical bond with the substrate (or previously deposited layers) in a region referred to as the fusion zone. The propagation of heat through the newly deposited layer to the substrate (or previously deposited layers) may in some instances affect material properties within a region referred to as the heat affected zone. The solidification process may also cause metallurgical defects such as pores and cracks to form in the deposited layer. The quantity and type of defects that arise are dependent on the amount of heat input, the time spent at elevated temperatures, the geometry of the printed part, and the presence of contaminants near the melt pool.

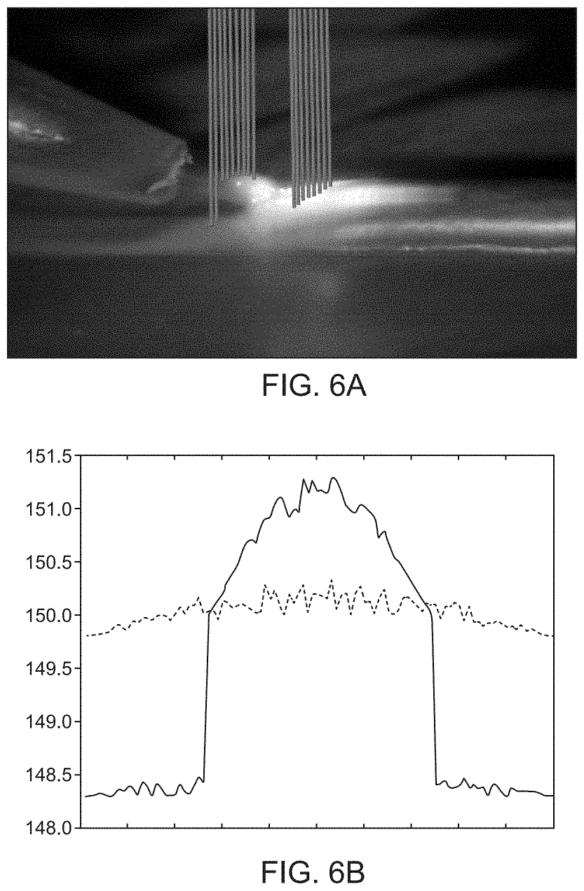

FIGS. 6A-B illustrate the use of laser interferometry to monitor melt pool and deposition layer properties in a laser-metal wire deposition process. FIG. 6A shows a micrograph of the deposition process at the location where the laser beam impinges on the metal wire. The vertical lines indicate the position of the interferometer probe beam as it is used to monitor the height profile of the wire feed and previously deposited layer and resulting melt pool. FIG. 6B provides examples of cross-sectional profiles (i.e., height profiles across the width of the deposition) of the wire feed, previously deposited layer, and melt pool as measured using laser interferometry at the position of the wire feed (solid line; the peak indicates the wire, while the shoulders indicate the height of the previously deposited layer) and the melt pool (dashed line). The x-axis (width) dimension is plotted in arbitrary units. The y-axis (height) dimension is plotted in units of millimeters relative to a fixed reference point below the deposition layer. In some embodiments of the disclosed adaptive process control methods, such real-time process monitoring data may be used by a processor running a machine learning algorithm to make adjustment(s) to one or more process control parameters in order to improve, for example, the dimensional accuracy of the layer, layer surface finish and/or adhesion properties, and/or the overall efficiency of the deposition process.

In some embodiments, laser interferometry may be used to monitor the dimensions and/or properties of the part being fabricated at one or more positions on the part. In some embodiment, laser interferometry may be used to monitor the dimensions and/or properties of the part being fabricated at at least 1, at least 2, at least 3, at least 4, at least 5, at least 6, at least 7, at least 8, at least 9, or at least 10 different positions on the part. In some embodiment, the laser interferometry data for dimensions and/or other properties of the part may be updated at a rate of at least 0.1 Hz, 1 Hz, 5 Hz, 10 Hz, 20 Hz, 30 Hz, 40 Hz, 50 Hz, 60 Hz, 70 Hz, 80 Hz, 90 Hz, 100 HZ, 250 Hz, 500 Hz, 750 Hz, 1,000 Hz, 2,500 Hz, 5,000 Hz, 10,000 Hz, 25,000 Hz, 50,000 Hz, 100,000 Hz, 150,000 Hz, 200,000 Hz, 250,000 Hz, or higher. Those of skill in the art will recognize that the rate at which the interferometry data may be updated may have any value within this range, e.g., about 800 Hz.

Machine vision systems: Another specific example of a manufacturing process monitoring tool that may be used with, for example, a CNC milling machine or a laser-metal wire deposition system is machine vision. Machine vision systems provide imaging-based automatic inspection and analysis for a variety of industrial inspection, process control, and robot guidance applications, and may comprise any of a variety of image sensors or cameras, light sources or illumination systems, and additional imaging optical components, as well as processors and image processing software.

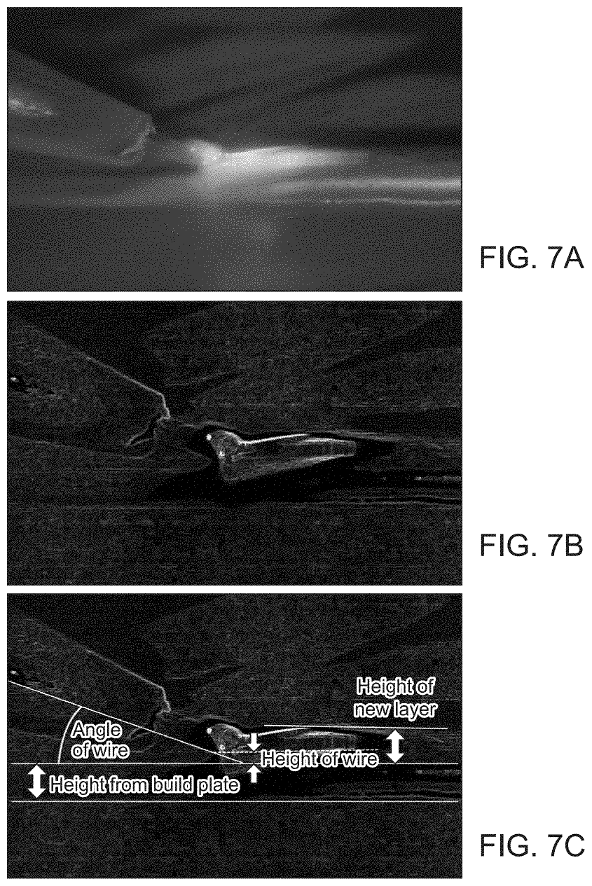

FIGS. 7A-C illustrate in-process feature extraction from images of a laser-metal wire deposition process obtained using a machine vision system. FIG. 7A shows a raw image (e.g., one image frame grabbed from a video rate data stream) of the melt pool adjacent to the tip of the wire. FIG. 7B shows the processed image after de-noising, filtering, and edge detection algorithms have been applied. FIG. 7C shows the processed image after application of a feature extraction algorithm used to identify, for example, the angel of the wire relative to the build plate and the height (thickness) of the new layer. Machine vision systems and the associated image processing capability allow one to monitor details of the deposition process in real-time.

In some embodiments, one or more machine vision systems may be used with the disclosed adaptive manufacturing process control methods and systems to acquire and process single images. In some embodiments, one or more machine vision systems may be used with the disclosed adaptive manufacturing process control methods and systems to acquire and process a series of one or more images at defined time intervals. In many embodiments, one or more machine vision systems may be used with the disclosed adaptive manufacturing process control methods and systems to acquire and process video rate image data. In general, image data supplied by the one or more machine vision systems may be acquired and/or processed at a rate of at least 0.1 Hz, 1 Hz, 5 Hz, 10 Hz, 20 Hz, 30 Hz, 40 Hz, 50 Hz, 60 Hz, 70 Hz, 80 Hz, 90 Hz, 100 HZ, 250 Hz, 500 Hz, 750 Hz, 1,000 Hz, 2,500 Hz, 5,000 Hz, or higher. Those of skill in the art will recognize that the rate at which image data may be acquired and/or processed may have any value within this range, e.g., 95 Hz.

In some embodiments, one or more machine vision systems used with the disclosed adaptive manufacturing process control methods and systems may be configured to acquire images at specific wavelengths (or within specific wavelength ranges) or in different imaging modes. For example, in some embodiments, one or more machine vision system may be configured to acquire images in the x-ray region, ultraviolet region, visible region, near infrared region, infrared region, terahertz region, microwave region, or radiofrequency region of the electromagnetic spectrum, or any combination thereof. In some embodiments, one or more machine vision systems may be configured to acquire fluorescence images (e.g., where the wavelength range for the excitation light is different than that for the collected fluorescence emission light). In some embodiments, one or more machine vision systems may be configured to acquire coherent Raman scattering (CRS) images (e.g., stimulated Raman scattering (SRS) or anti-Stokes Raman scattering (CARS) images) to provide label-free chemical imaging of the deposition layer or part being fabricated.

Post-Build Inspection Tools and Automated Defect Classification:

Disclosed herein are automated object defect classification methods and systems used to identify and characterize defects in fabricated parts. The approach is based on the use of a machine learning algorithm for detection and classification of defects, where the machine learning algorithm is trained using a training dataset that comprises post-build inspection data provided by a skilled operator and/or inspection data provided by any of a variety of automated inspection tools known to those of skill in the art. The disclosed automated object defect classification methods and systems may be applied to any of a variety of manufacturing processes known to those of skill in the art. In some embodiments, the disclosed automated object defect classification methods and systems may be used strictly for post-build inspection of new parts. In some embodiments, they may be used in-process to provide real-time process characterization data to a machine learning algorithm used to run the manufacturing process control, so that one or more process control parameters may be adjusted in real-time. In some embodiments, the disclosed automated object defect classification methods and systems may be used both in-process to provide real-time process characterization data and for post-build inspection. In some embodiments, in-process automated defect classification data may be used by the machine learning algorithm to determine a set or sequence of process control parameter adjustments that will implement a corrective action, e.g., to adjust a layer dimension or thickness in an additive manufacturing process, so as to correct a defect when first detected. In some embodiments, in-process automated defect classification may be used by the machine learning algorithm to send a warning or error signal to an operator, or optionally, to automatically abort the deposition process, e.g., an additive manufacturing process. In some embodiments, once trained, the automated defect classification system requires no further user input (e.g., no further input from a skilled operator or inspector) to detect and classify defects either in-process and/or post-build.

The automated object defect classification methods will generally comprise: a) providing a training data set, wherein the training data set comprises manufacturing process simulation data, manufacturing process characterization data, in-process inspection data, and/or post-build inspection data, or any combination thereof, for a plurality of object designs that are the same as or different from that of the manufactured object; b) providing one or more sensors, wherein the one or more sensors provide real-time data for one or more manufactured object properties; c) providing a processor programmed to provide a classification of detected manufactured object defects using a machine learning algorithm that has been trained using the training data set of step (a), wherein the real-time data from the one or more sensors is provided as input to the machine learning algorithm and allows the classification of detected object defects to be adjusted in real-time. A novel feature of the disclosed methods for automated classification of object defects is that the machine learning algorithms used for detection and classification of object defects may, in some embodiments, be trained using a training data set that comprises manufacturing process simulation data, manufacturing process characterization data, in-process inspection data, and/or post-build inspection data, or any combination thereof, for a plurality of object designs that are the same as or different from that of the manufactured object currently being fabricated.

Training data sets: As noted above, the training data set may comprise manufacturing process simulation data, manufacturing process characterization data, in-process inspection data, post-build inspection data (including inspection data provided by a skilled operator and/or inspection data provided by any of a variety of automated inspection tools), or any combination thereof, for past fabrication runs of a plurality of design geometries that are the same as or different from that of the object currently being fabricated or assembled. For example, in an embodiment in which a manufacturing process such as a CNC machining process has been configured to fabricate a rocket engine combustion chamber comprising a plurality of narrow slots and through holes, the training data set for the machine learning algorithm used to detect and classify object defects; and control applied forces, tool rotational rates, tool translational rates may comprise process simulation data, process characterization data, in-process inspection data, post-build inspection data, or any combination thereof, for brackets, gears, housings, etc., that differ from the combustion chamber being fabricated in terms of design and/or material. One or more training data sets may be used to train the machine learning algorithm used for object defect detection and classification. In some cases, the type of data included in the training data set may vary depending on the specific type of machine learning algorithm employed, as will be discussed in more detail below. For example, in the case that an expert system (or expert learning system) the training data set may comprise primarily defect classification data provided by a skilled operator or technician in visually identifying and classifying object defects for the same type of part or for a variety of different parts that share some common set of features. In some instances, the training data set may be updated in real-time with object defect and object classification data as it is performed on a given system. In some instances, the training data may be updated with object defect data and object classification data drawn from a plurality of automated defect classification systems.

In some embodiments, the training data set may comprise manufacturing process simulation data, manufacturing process characterization data, in-process inspection data, post-build inspection data, or any combination thereof. In some embodiments, the training data set may comprise a single type of data selected from the group consisting of process simulation data, process characterization data, in-process inspection data, and post-build inspection data. In some embodiments, the training data set may comprise a combination of any two or any three types of data selected from the group consisting of process simulation data, process characterization data, in-process inspection data, and post-build inspection data. In some embodiments, the training data set may comprise all of these types of data, i.e., process simulation data, process characterization data, in-process inspection data, and post-build inspection data.

Object property measurement: Any of a variety of sensors or other inspection tools may be used, including some of those listed above for process monitoring in general. In some embodiments, the one or more sensors (e.g., image sensors, cameras, or machine vision systems) provide data on electromagnetic radiation that is reflected, scattered, absorbed, transmitted, or emitted by the object. In some embodiments, the electromagnetic radiation is x-ray, ultraviolet, visible, near-infrared, or infrared light. In some embodiments, the one or more sensors provide data on acoustic energy that is reflected, scattered, absorbed, transmitted, or emitted by the object. In some embodiments, the one or more sensors provide data on an electrical conductivity or a thermal conductivity of the object. In some embodiments, the one or more sensors may provide data to the processor programmed to provide a classification of detected object defects using a machine learning algorithm at an update rate of at least 0.1 Hz, 1 Hz, 5 Hz, 10 Hz, 20 Hz, 30 Hz, 40 Hz, 50 Hz, 60 Hz, 70 Hz, 80 Hz, 90 Hz, 100 HZ, 250 Hz, 500 Hz, 750 Hz, 1,000 Hz, 2,500 Hz, 5,000 Hz, 10,000 Hz, or higher. Those of skill in the art will recognize that the one or more sensors or process monitoring tools may provide data at an update rate having any value within this range, e.g., about 400 Hz.

In a preferred embodiment the automated object defect classification methods and systems of the present disclosure may be implemented using image sensors, cameras, and/or machine vision systems. Automated image processing of the captured images may then be used to monitor any of a variety of object properties, e.g., dimensions (overall dimensions, or dimensions of specific features), feature angles, feature areas, surface finish (e.g., degree of light reflectivity, number of pits and/or scratches per unit area), and the like. In some embodiments, object properties such as local, excessively high temperatures that may be correlated with defects or defect generation in printed or welded parts may be monitored using infrared or visible wavelength cameras.

Noise removal from sensor data: In some embodiments, the automated defect classification methods may further comprise removing noise from the object property data provided by the one or more sensors prior to providing it to the machine learning algorithm. Examples of data processing algorithms suitable for use in removing noise from the object property data provided by the one or more sensors include, but are not limited to, signal averaging algorithms, smoothing filter algorithms, Kalman filter algorithms, nonlinear filter algorithms, total variation minimization algorithms, or any combination thereof.

Subtraction of reference data sets: In some embodiments of the disclosed automated defect classification methods, subtraction of a reference data set from the sensor data may be used to increase contrast between normal and defective features of the object, thereby facilitating defect detection and classification. For example, a reference data set may comprise sensor data recorded by one or more sensors for an ideal, defect-free example of the object to be fabricated. In the case that an image sensor or machine vision system is used for defect detection, the reference data set may comprise an image (or set of images, e.g., representing different views) of an ideal, defect-free object.

Machine learning algorithms for defect detection and classification: Any of a variety of machine learning algorithms may be used in implementing the disclosed automated object defect detection and classification methods. The machine learning algorithm employed may comprise a supervised learning algorithm, an unsupervised learning algorithm, a semi-supervised learning algorithm, a reinforcement learning algorithm, a deep learning algorithm, or any combination thereof. In preferred embodiments, the machine learning algorithm employed for defect identification and classification may comprise a support vector machine (SVM), an artificial neural network (ANN), or a decision tree-based expert learning system, some of which will be described in more detail below. In some preferred embodiments, object defects may be detected as differences between an object property data set and a reference data set that are larger than a specified threshold, and may be classified using a one-class support vector machine (SVM) or autoencoder algorithm. In some preferred embodiments, object defects may be detected and classified using an unsupervised one-class support vector machine (SVM), autoencoder, clustering, or nearest neighbor (e.g., kNN) machine learning algorithm and a training data set that comprises object property data for both defective and defect-free objects.

Adaptive, Real-Time Manufacturing Process Control Using a Machine Learning Algorithm:

Disclosed herein are methods and systems for providing real-time adaptive control of any of a variety of manufacturing processes (i.e., fabrication processes rather than design processes) known to those of skill in the art. In general, the disclosed methods comprise a) providing an input design for an object (e.g., a 3D CAD model); b) providing a training data set, wherein the training data set comprises process simulation data, process characterization data, in-process inspection data, post-build inspection data, or any combination thereof, for a plurality of object designs or portions thereof that are the same as or different from the input object design of step (a); c) providing a starting set or sequence of one or more manufacturing process control parameters for fabricating or assembling the object, wherein, in some cases, a predicted optimal starting set of one or more process control parameters are derived using a machine learning algorithm that has been trained using the training data set of step (b); and d) performing the manufacturing process to fabricate or assemble the object, wherein real-time process characterization data or in-process inspection data is provided by one or more sensors as input to the machine learning algorithm trained using the training data set of step (b) to adjust one or more manufacturing process control parameters in real-time. In some embodiments, steps (b)-(d) are performed iteratively and the process characterization data, in-process inspection data, post-build inspection data, or any combination thereof, for each iteration is incorporated into the training data set. The disclosed process control methods may be used for any of a variety of manufacturing processes known to those of skill in the art. For instance, examples of additive manufacturing and welding processes known to those of skill in the art include, but are not limited to, stereolithography (SLA), digital light processing (DLP), fused deposition modeling (FDM), selective laser sintering (SLS), selective laser melting (SLM), electronic beam melting (EBM) process, laser beam welding, MIG (metal inert gas) welding, TIG (tungsten inert gas) welding, and the like. In one preferred embodiment, the disclosed process control methods are applied to a liquid-to-solid free form deposition process, for example, to a laser metal-wire deposition process.

Training data sets: As with the automated defect classification methods described above, the training data set(s) used in teaching the process control machine learning algorithm may comprise manufacturing process simulation data, manufacturing process characterization data, in-process inspection data, post-build inspection data (including inspection data provided by a skilled operator and/or inspection data provided by any of a variety of automated inspection tools), or any combination thereof, for past manufacturing runs of a plurality of object designs that are the same as or different from that of the object currently being fabricated. For example, in an embodiment in which a manufacturing process such as a CNC machining process has been configured to fabricate a rocket engine combustion chamber comprising a plurality of narrow slots and through holes, the training data set for the machine learning algorithm used to detect and classify object defects; and control applied forces, tool rotational rates, tool translational rates may comprise process simulation data, process characterization data, in-process inspection data, post-build inspection data, or any combination thereof, for brackets, gears, housings, etc., that differ from the combustion chamber being fabricated in terms of design and/or material. One or more training data sets may be used to train the machine learning algorithm used for adaptive, real-time manufacturing process control. In some cases, the type of data included in the training data set may vary depending on the specific type of machine learning algorithm employed, as will be discussed in more detail below. For example, in some cases the training data set may comprise primarily process control settings provided by a skilled operator or technician in successfully fabricating a number of the same type of part or for a variety of different parts that share some common set of features. In some instances, the training data set may be updated in real-time using process simulation data, process control data, process characterization data, in-process inspection data, and/or post-build inspection data as fabrication is performed on a given system. In some instances, the training data may be updated using process simulation data, process control data, process characterization data, in-process inspection data, and/or post-build inspection data as fabrication or assembly is performed on a plurality of manufacturing systems.

In some embodiments, the training data set may comprise process simulation data, process characterization data, in-process inspection data, post-build inspection data, or any combination thereof. In some embodiments, the training data set may comprise a single type of data selected from the group consisting of process simulation data, process characterization data, in-process inspection data, and post-build inspection data. In some embodiments, the training data set may comprise a combination of any two or any three types of data selected from the group consisting of process simulation data, process characterization data, in-process inspection data, and post-build inspection data. In some embodiments, the training data set may comprise all of these types of data, i.e., process simulation data, process characterization data, in-process inspection data, and post-build inspection data.

Process characterization data: Any of a variety of sensors, measurement tools, or inspection tools may be used for monitoring various manufacturing process parameters in real-time, including those listed above. In some embodiments, for example, laser interferometers are used to monitor the dimensions of the melt pool (in the case of laser-metal wire deposition) or other part dimensions as the part is being fabricated. In some embodiments, the one or more sensors (e.g., image sensors, cameras, or machine vision systems) provide data on electromagnetic radiation that is reflected, scattered, absorbed, transmitted, or emitted by the object. In some embodiments, the electromagnetic radiation is x-ray, ultraviolet, visible, near-infrared, or infrared light. In some embodiments, real-time image acquisition and processing is used to monitor, for example, the angle of the wire feed relative to a baseplate or previously deposited layer in a laser-metal wire deposition process, or the thickness of a deposited layer in an additive manufacturing process. In some embodiments, the one or more sensors provide data on acoustic energy that is reflected, scattered, absorbed, transmitted, or emitted by the object. In some embodiments, the one or more sensors provide data on an electrical conductivity or a thermal conductivity of the object. In some embodiments, the one or more sensors may provide process characterization data to the processor programmed to run the machine learning algorithm may be updated ata rate of at least 0.1 Hz, 1 Hz, 5 Hz, 10 Hz, 20 Hz, 30 Hz, 40 Hz, 50 Hz, 60 Hz, 70 Hz, 80 Hz, 90 Hz, 100 HZ, 250 Hz, 500 Hz, 750 Hz, 1,000 Hz, 2,500 Hz, 5,000 Hz, 10,000 Hz, or higher. Those of skill in the art will recognize that the one or more process characterization sensor may provide data at an update rate having any value within this range, e.g., about 8,000 Hz.

In a preferred embodiment, the real-time process characterization data that is fed to the machine learning algorithm used to run process control may comprise data supplied by an automated object defect classification system as described above, so that the manufacturing process control parameters may be adjusted in real-time to compensate or correct for part defects as they arise during the build process. The machine learning algorithm used to run the automated process control may be configured to adjust the process control parameters in real-time as necessary to maximize a reward function (or to minimize a loss function), as will be discussed in more detail below.

Machine learning algorithms for automated deposition process control: Any of a variety of machine learning algorithms may be used in implementing the disclosed manufacturing process control methods, and may be the same or different from those used to implement the automated object defect classification methods described above. The machine learning algorithm employed may comprise a supervised learning algorithm, an unsupervised learning algorithm, a semi-supervised learning algorithm, a reinforcement learning algorithm, a deep learning algorithm, or any combination thereof. In preferred embodiments, the machine learning algorithm employed may comprise an artificial neural network algorithm, a Gaussian process regression algorithm, a logistical model tree algorithm, a random forest algorithm, a fuzzy classifier algorithm, a decision tree algorithm, a hierarchical clustering algorithm, a k-means algorithm, a fuzzy clustering algorithm, a deep Boltzmann machine learning algorithm, a deep convolutional neural network algorithm, a deep recurrent neural network, or any combination thereof, some of which will be described in more detail below.

Reward functions and loss functions: As noted above, in some embodiments the machine learning algorithm used to run the automated manufacturing process control may be configured to adjust the process control parameters in real-time as necessary to maximize a reward function (or to minimize a loss function) in order to optimize the deposition process. As used herein, a reward function (or conversely, a loss function (sometimes also referred to as a cost function or error function)) refers to a function that maps the values of one or more manufacturing process process variables and/or fabrication event outcomes to a real number that represents the “reward” associated with a given fabrication event (or the “cost” in the case of a loss function). Examples of process parameters and fabrication event outcomes that may be used in defining a reward (or loss) function include, but are not limited to, process throughput (e.g. number of parts fabricated per unit time), process yield (e.g., the percentage of parts produced that meet a specified set of quality criteria), production quality (e.g., mean squared deviation in part dimension(s) between the parts produced and an ideal, defect-free reference part, or the average number of defects detected per part produced), production cost (e.g., the cost per part produced), and the like. In some cases, the definition of the reward function (or loss function) to be maximized (or minimized) may be dependent on the choice of machine learning algorithm used to run the process control method, and vice versa. For example, if the objective is to maximize a total reward/value function, a reinforcement learning algorithm may be chosen. If the objective is to minimize a mean squared error cost (or loss) function, a decision tree regression algorithm or linear regression algorithm may be chosen. In general, the machine learning algorithm used to run the process control method will seek to optimize the reward function (or minimize the loss function) by (i) identifying the current “state” of the part under fabrication (e.g., based on the real-time stream of process characterization data supplied by one or more sensors), (ii) comparing the current “state” to the design target (or reference “state”), and (iii) adjusting one or more process control parameters in order to minimize the difference between the two states (e.g., based on past “learning” provided by the training data set).

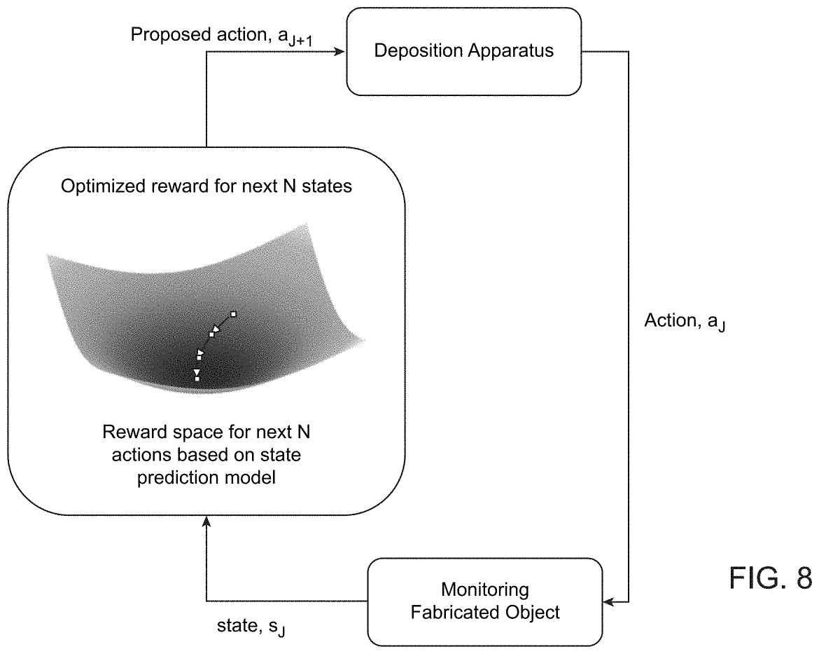

FIG. 8 illustrates an action prediction—reward loop for a reinforcement learning algorithm according to some embodiments of the disclosed manufacturing process control methods. In the case of a deposition process, for example, at any point in time during or following completion of layer deposition (action aⱼ), the part being fabricated is monitored using any of a variety of sensors, measuring tools, inspection tools, and/or machine vision systems as described above to determine the current build “state” of the part (state sⱼ). In a preferred embodiment, the part is monitored in real-time using an automated object defect classification system as disclosed herein. Once the current build state of the part has been determined, a reinforcement learning algorithm uses the current state information, sⱼ, and the model developed using past training data to predict a proposed action, aⱼ₊₁, (e.g., a set or sequence of process control parameter adjustments) that will maximize a reward function. If the current build state, sⱼ, is relatively poor (i.e., associated with a low value of the reward function), it may not be desirable to simply take the set of actions that produces the highest reward in the next build state, sⱼ₊₁, because that may not produce the maximum reward in the long run. In some cases, maximizing the reward for the immediate next build state, sⱼ₊₁, may force a decision between very low reward states for next few build states, e.g., sⱼ₊₂, s₁₊₃, s₁₊₄, thereafter. By using the learned process model to look a bit further into the future, one can optimize the process control parameter adjustments for the next N build states as opposed to just the immediate next state. Each set of “next N states” starting from state sᵢ has a corresponding reward (i.e., the reward space for the next N actions) that can be predicted using the previously trained model that predicts the correlation between actions and their resulting state. Thus the learned model may be used to determine a sequence of actions that optimizes the sum (or weighted sum) of reward values for the next N states. The loop is repeated until the part is complete, and provides adaptive control of the deposition process (in this example) to provide for rapid optimization and adjustment of the process control parameters used in response to changes in process or environmental parameters, as well as improved process yield, process throughput, and quality of the parts.

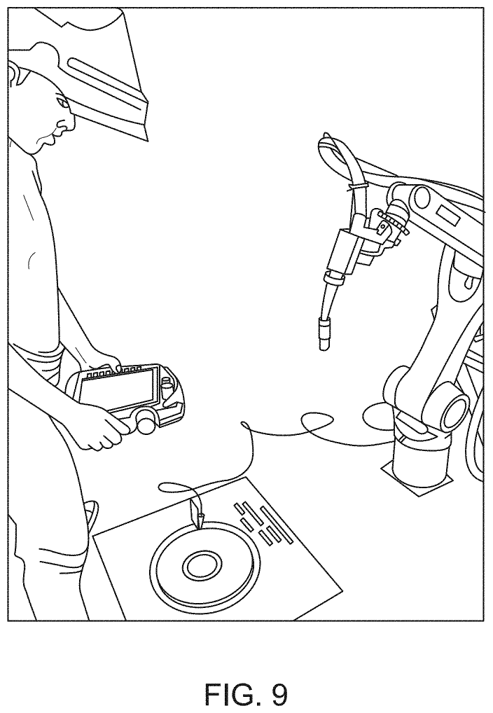

FIG. 9 illustrates reward function construction where the training data used to generate the reward function-based state prediction model is acquired by monitoring the actions that a human operator chooses during a manually-controlled deposition process. In some embodiments, the machine learning algorithm may be wholly or partially self-trained. For example, in some embodiments, as part of the training of the machine learning algorithm, the machine learning algorithm may randomly choose values within a specified range for each of a set of one or more process control parameters, and incorporate the resulting process simulation data, process characterization data, in-process inspection data, post-build inspection data, or any combination thereof, into the training data set to improve a learned model that maps process control parameter values to process outcomes.

In general, the methods and systems for adaptive, real-time control of manufacturing processes that are disclosed herein do not rely on static data look-up operations (e.g., looking up process control parameters or process characterization data from previous runs). Rather, a machine learning algorithm is used to explore a range of input values for one or more process control parameters during process simulation and/or actual part fabrication or assembly, and generates a learned model that maps input process control parameters to process outcomes under a variety of different process and environmental conditions.

Process control parameter update rates: In some embodiments, the one or more sensors may provide data to the processor programmed to run a machine learning algorithm so that one or more process control parameters may be adjusted at an update rate of at least 0.1 Hz, 1 Hz, 5 Hz, 10 Hz, 20 Hz, 30 Hz, 40 Hz, 50 Hz, 60 Hz, 70 Hz, 80 Hz, 90 Hz, 100 HZ, 250 Hz, 500 Hz, 750 Hz, 1,000 Hz, 2,500 Hz, 5,000 Hz, 10,000 Hz, or higher. Those of skill in the art will recognize that the one or more process control parameters may be adjusted or updated at a rate having any value within this range, e.g., about 8,000 Hz.

Machine Learning Algorithms for Adaptive Process Control:

As noted above, the machine learning algorithm(s) employed in the disclosed automated defect classification and additive manufacturing process control methods may comprise a supervised learning algorithm, an unsupervised learning algorithm, a semi-supervised learning algorithm, a reinforcement learning algorithm, a deep learning algorithm, or any combination thereof.

Supervised learning algorithms: In the context of the present disclosure, supervised learning algorithms are algorithms that rely on the use of a set of labeled training data to infer the relationship between a set of one or more defects identified for a given object and a classification of the object according to a specified set of quality criteria, or to infer the relationship between a set of input manufacturing process control parameters and a set of desired fabrication or assembly outcomes. The training data comprises a set of paired training examples, e.g., where each example comprises a set of defects detected for a given object and the resultant classification of the given object, or where each example comprises a set of process control parameters that were used in a fabrication or assembly process that is paired with the known outcome of the fabrication or assembly process.

Unsupervised learning algorithms: In the context of the present disclosure, unsupervised learning algorithms are algorithms used to draw inferences from training datasets consisting of object defect datasets that are not paired with labeled object classification data, or input manufacturing process control parameter data that are not paired with labeled fabrication or assembly outcomes. The most commonly used unsupervised learning algorithm is cluster analysis, which is often used for exploratory data analysis to find hidden patterns or groupings in process data.

Semi-supervised learning algorithms: In the context of the present disclosure, semi-supervised learning algorithms are algorithms that make use of both labeled and unlabeled object classification or manufacturing process data for training (typically using a relatively small amount of labeled data with a large amount of unlabeled data).

Reinforcement learning algorithms: In the context of the present disclosure, reinforcement learning algorithms are algorithms which are used, for example, to determine a set of manufacturing process steps (or actions) that should be taken so as to maximize a specified fabrication or assembly process reward function. In machine learning environments, reinforcement learning algorithms are often formulated as Markov decision processes. Reinforcement learning algorithms differ from supervised learning algorithms in that correct training data input/output pairs are never presented, nor are sub-optimal actions explicitly corrected. These algorithms tend to be implemented with a focus on real-time performance through finding a balance between exploration of possible outcomes based on updated input data and exploitation of past training.

Deep learning algorithms: In the context of the present disclosure, deep learning algorithms are algorithms inspired by the structure and function of the human brain called artificial neural networks (ANNs), and specifically large neural networks comprising many layers, that are used to map object defect data to object classification decisions, or to map input manufacturing process control parameters to desired fabrication or assembly outcomes. Artificial neural networks will be discussed in more detail below.

Decision tree-based expert systems: In the context of the present disclosure, expert systems are one example of supervised learning algorithms that are designed to solve object defect classification problems or manufacturing process control problems by applying a series of if—then rules. Expert systems typically comprise two subsystems: an inference engine and a knowledge base. The knowledge base comprises a set of facts (e.g., a training data set comprising object defect data for a series of fabricated parts, and the associated object classification data provided by a skilled operator, technician, or inspector) and derived rules (e.g., derived object classification rules). The inference engine then applies the rules to data for a current object classification problem or process control problem to determine a classification of the object or a next set of process control adjustments.

Support vector machines (SYMs): In the context of the present disclosure, support vector machines are supervised learning algorithms used for classification and regression analysis of object defect classification date or manufacturing process control. Given a set of training data examples (e.g., object defect data), each marked as belonging to one or the other of two categories (e.g., good or bad, pass or fail), an SVM training algorithm builds a model that assigns new examples (e.g., defect data for a newly fabricated object) to one category or the other.

Autoencoders: In the context of the present disclosure, an autoencoder (also sometimes referred to as an autoassociator or Diabolo network) is an artificial neural network used for unsupervised, efficient mapping of input data, e.g., object defect data, to an output value, e.g., an object classification. Autoencoders are often used for the purpose of dimensionality reduction, i.e., the process of reducing the number of random variables under consideration by deducing a set of principal component variables. Dimensionality reduction may be performed, for example, for the purpose of feature selection (i.e., a subset of the original variables) or feature extraction (i.e., transformation of data in a high-dimensional space to a space of fewer dimensions).

Artificial neural networks (ANNs): In some cases, the machine learning algorithm used for the disclosed automated object defect classification or adaptive manufacturing process control methods may comprise an artificial neural network (ANN), e.g., a deep machine learning algorithm. The automated object classification methods of the present disclosure may, for example, employ an artificial neural network to map object defect data to object classification data. The manufacturing process control systems of the present disclosure may, for example, employ an artificial neural network (ANN) to determine an optimal set or sequence of process control parameter settings for adaptive control of a manufacturing process in real-time based on a stream of process monitoring data and/or object defect classification data provided by one or more sensors. The artificial neural network may comprise any type of neural network model, such as a feedforward neural network, radial basis function network, recurrent neural network, or convolutional neural network, and the like. In some embodiments, the automated object defect classification and manufacturing process control methods and systems of the present disclosure may employ a pre-trained ANN architecture. In some embodiment, the automated object defect classification and additive manufacturing process control methods and systems of the present disclosure may employ an ANN architecture wherein the training data set is continuously updated with real-time object classification data or real-time manufacturing process control and monitoring data from a single local manufacturing apparatus or system, from a plurality of local manufacturing apparatuses or systems, or from a plurality of geographically distributed manufacturing apparatuses or systems.

As used throughout this disclosure, the term “real-time” refers to the rate at which sensor data (e.g. process control data, process monitoring data, and/or object defect identification and classification data) is acquired, processed, and/or used by a machine learning algorithm, e.g., an artificial neural network or deep machine learning algorithm, to update a prediction of object classification or a prediction of optimal process control parameters in response to changes in one or more of the input sensor data streams. In general the update rate for the object classification or process control parameters provided by the disclosed object defect classification and additive manufacturing process control methods and systems may range from about 0.1 Hz to about 10,000 Hz. In some embodiments, the update rate may be at least 0.1 Hz, at least 1 HZ, at least 10 Hz, at least 50 Hz, at least 100 Hz, at least 250 Hz, at least 500 Hz, at least 750 Hz, at least 1,000 Hz, at least 2,000 Hz, at least 3,000 Hz, at least 4,000 Hz, at least 5,000 Hz, or at least 10,000 Hz. In some embodiments, the update rate may be at most 10,000 Hz, at most 5,000 Hz, at most 4,000 Hz, at most 3,000 Hz, at most 2,000 Hz, at most 1,000 Hz, at most 750 Hz, at most 500 Hz, at most 250 Hz, at most 100 Hz, at most 50 Hz, at most 10 Hz, at most 1 Hz, or at most 0.1 Hz. Those of skill in the art will recognize that the update rate may have any value within this range, for example, about 8,000 Hz.

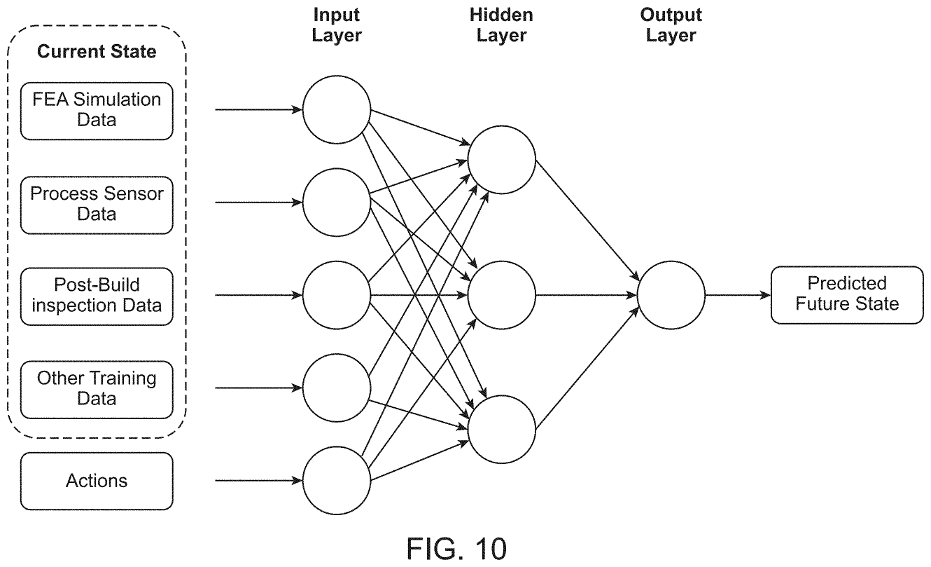

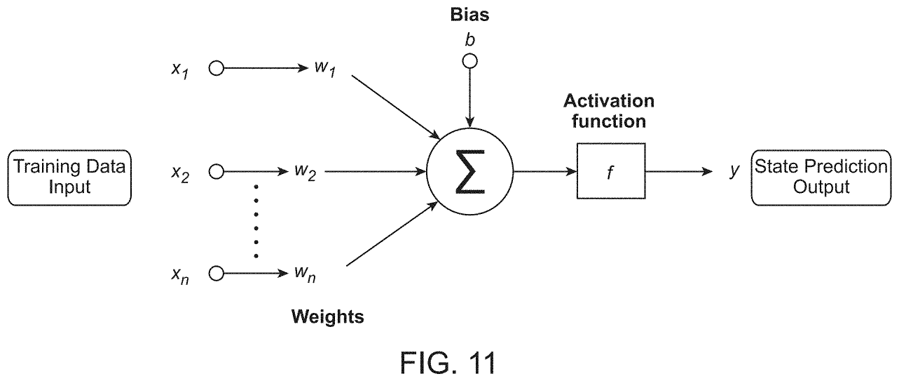

Artificial neural networks generally comprise an interconnected group of nodes organized into multiple layers of nodes (see FIG. 10). For example, the ANN architecture may comprise at least an input layer, one or more hidden layers, and an output layer. The ANN may comprise any total number of layers, and any number of hidden layers, where the hidden layers function as trainable feature extractors that allow mapping of a set of input data to a preferred output value or set of output values. Each layer of the neural network comprises a number of nodes (or neurons). A node receives input that comes either directly from the input data (e.g., sensor data, image data, object defect data, etc., in the case of the presently disclosed methods) or the output of nodes in previous layers, and performs a specific operation, e.g., a summation operation. In some cases, a connection from an input to a node is associated with a weight (or weighting factor). In some cases, the node may sum up the products of all pairs of inputs, xᵢ, and their associated weights, wᵢ (FIG. 11). In some cases, the weighted sum is offset with a bias, b, as illustrated in FIG. 11. In some cases, the output of a neuron may be gated using a threshold or activation function, f which may be a linear or non-linear function. The activation function may be, for example, a rectified linear unit (ReLU) activation function or other function such as a saturating hyperbolic tangent, identity, binary step, logistic, arcTan, softsign, parameteric rectified linear unit, exponential linear unit, softPlus, bent identity, softExponential, Sinusoid, Sinc, Gaussian, or sigmoid function, or any combination thereof.

The weighting factors, bias values, and threshold values, or other computational parameters of the neural network, can be “taught” or “learned” in a training phase using one or more sets of training data. For example, the parameters may be trained using the input data from a training data set and a gradient descent or backward propagation method so that the output value(s) (e.g., a set of predicted adjustments to process control parameter settings) that the ANN computes are consistent with the examples included in the training data set. The parameters may be obtained from a back propagation neural network training process that may or may not be performed using the same hardware as that used for automated object defect classification or adaptive, real-time manufacturing process control.

Other specific types of deep machine learning algorithms, e.g., convolutional neural networks (CNNs) (e.g., for the processing of image data from machine vision systems) may also be used by the disclosed methods and systems. CNN are commonly composed of layers of different types: convolution, pooling, upscaling, and fully-connected node layers. In some cases, an activation function such as rectified linear unit may be used in some of the layers. In a CNN architecture, there can be one or more layers for each type of operation performed. A CNN architecture may comprise any number of layers in total, and any number of layers for the different types of operations performed. The simplest convolutional neural network architecture starts with an input layer followed by a sequence of convolutional layers and pooling layers, and ends with fully-connected layers. Each convolution layer may comprise a plurality of parameters used for performing the convolution operations. Each convolution layer may also comprise one or more filters, which in turn may comprise one or more weighting factors or other adjustable parameters. In some instances, the parameters may include biases (i.e., parameters that permit the activation function to be shifted). In some cases, the convolutional layers are followed by a layer of ReLU activation function. Other activation functions can also be used, for example the saturating hyperbolic tangent, identity, binary step, logistic, arcTan, softsign, parameteric rectified linear unit, exponential linear unit, softPlus, bent identity, softExponential, Sinusoid, Sinc, Gaussian, the sigmoid function and various others. The convolutional, pooling and ReLU layers may function as learnable features extractors, while the fully connected layers may function as a machine learning classifier. In some embodiments, specific computer vision algorithms comprise hough lines. In some embodiments, computer vision algorithms comprise canny edge detectors.

As with other artificial neural networks, the convolutional layers and fully-connected layers of CNN architectures typically include various computational parameters, e.g., weights, bias values, and threshold values, that are trained in a training phase as described above.

In general, the number of nodes used in the input layer of the ANN (which enable input of data from multiple sensor data streams and/or, for example, sub-sampling of an image frame) may range from about 10 to about 10,000 nodes. In some instances, the number of nodes used in the input layer may be at least 10, at least 50, at least 100, at least 200, at least 300, at least 400, at least 500, at least 600, at least 700, at least 800, at least 900, at least 1000, at least 2000, at least 3000, at least 4000, at least 5000, at least 6000, at least 7000, at least 8000, at least 9000, or at least 10,000. In some instances, the number of node used in the input layer may be at most 10,000, at most 9000, at most 8000, at most 7000, at most 6000, at most 5000, at most 4000, at most 3000, at most 2000, at most 1000, at most 900, at most 800, at most 700, at most 600, at most 500, at most 400, at most 300, at most 200, at most 100, at most 50, or at most 10. Those of skill in the art will recognize that the number of nodes used in the input layer may have any value within this range, for example, about 512 nodes.

In some instance, the total number of layers used in the ANN (including input and output layers) may range from about 3 to about 20. In some instance the total number of layer may be at least 3, at least 4, at least 5, at least 10, at least 15, or at least 20. In some instances, the total number of layers may be at most 20, at most 15, at most 10, at most 5, at most 4, or at most 3. Those of skill in the art will recognize that the total number of layers used in the ANN may have any value within this range, for example, 8 layers.

In some instances, the total number of learnable or trainable parameters, e.g., weighting factors, biases, or threshold values, used in the ANN may range from about 1 to about 10,000. In some instances, the total number of learnable parameters may be at least 1, at least 10, at least 100, at least 500, at least 1,000, at least 2,000, at least 3,000, at least 4,000, at least 5,000, at least 6,000, at least 7,000, at least 8,000, at least 9,000, or at least 10,000. Alternatively, the total number of learnable parameters may be any number less than 100, any number between 100 and 10,000, or a number greater than 10,000. In some instances, the total number of learnable parameters may be at most 10,000, at most 9,000, at most 8,000, at most 7,000, at most 6,000, at most 5,000, at most 4,000, at most 3,000, at most 2,000, at most 1,000, at most 500, at most 100 at most 10, or at most 1. Those of skill in the art will recognize that the total number of learnable parameters used may have any value within this range, for example, about 2,200 parameters.

Integrated and Distributed Manufacturing Systems:

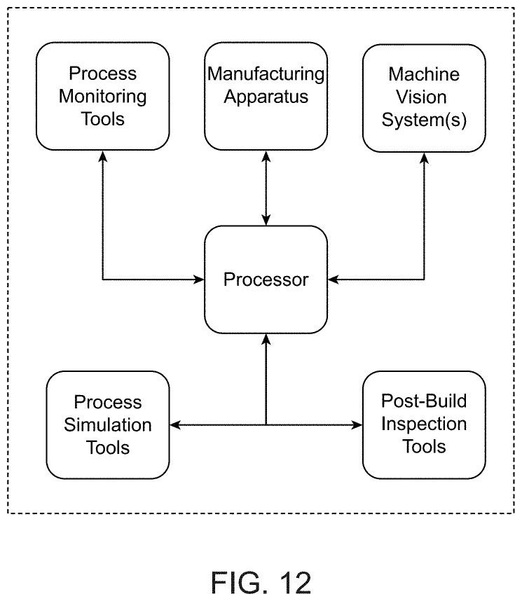

In some embodiments, the adaptive, real-time process control methods of the present disclosure may be used for control of integrated manufacturing systems (e.g., free form deposition or joining systems) that reside at a single physical/geographical location. FIG. 12 provides a schematic illustration of an integrated manufacturing system comprising a deposition apparatus, one or more machine vision systems and/or other process monitoring tools, process simulation tools, post-build inspection tools, and one or more processors for running a machine learning algorithm that utilizes data from the process simulation tools, machine vision and/or process monitoring tools (including in-process inspection and/or defect classification tools), post-build inspection tools, or any combination thereof, to provide real-time adaptive control of the deposition process, where the components of the system are located in the same physical/geographical location. In these embodiments, the processor may communicate with the individual system components through direct, hard-wired connections and/or via short-range communication links such as Bluetooth® (using short-wavelength, ultra-high frequency (UHF) radio waves in the industrial, scientific, and medical (ISM) radio band from 2.4 to 2.485 GHz) or WiFi™ (e.g., using the 2.4 GHz and 5.8 GHz ISM radio bands) connections. In some embodiments, two or more of the system components may be housed within an enclosure or housing (dashed line) that enables tighter control of fabrication environmental parameters such as temperature, pressure, atmospheric composition, etc.

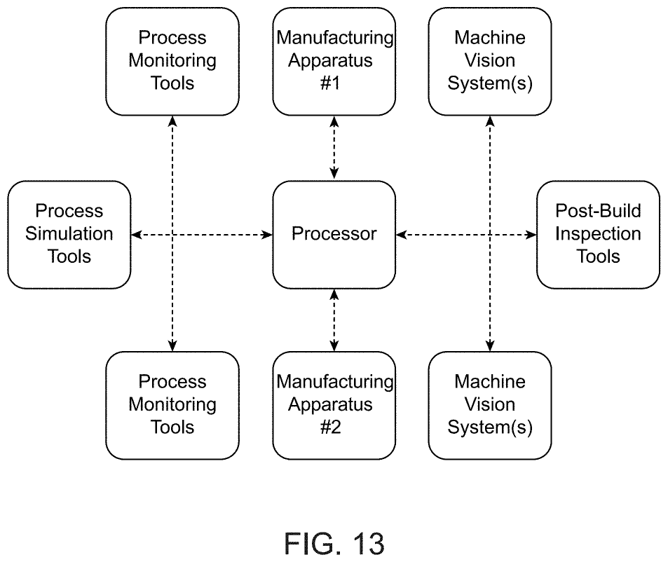

FIG. 13 provides a schematic illustration of a distributed manufacturing system, e.g., an additive manufacturing system, comprising one or more deposition apparatus, process simulation tools, machine vision systems and/or other process monitoring tools, in-process inspection tools, post-build inspection tools, and one or more processors for running a machine learning algorithm that utilizes data from the machine vision and/or process monitoring tools, the process simulation tools, the post-build inspection tools, or any combination thereof, to provide real-time adaptive control of the deposition process, where the different components or modules of the system may be physically located in different workspaces and/or worksites (i.e. different physical/geographical locations), and may be linked via a local area network (LAN), an intranet, an extranet, or the internet so that process data (e.g., training data, process simulation data, process control data, in-process inspection data, and/or post-build inspection data) and process control instructions may be shared and exchanged between the different modules. In some embodiments, some of the co-localized system components (e.g., a deposition apparatus and a process monitoring tool) may be housed within a local enclosure or housing (not shown) that enables tighter control of fabrication environmental parameters such as temperature, pressure, atmospheric composition, etc.

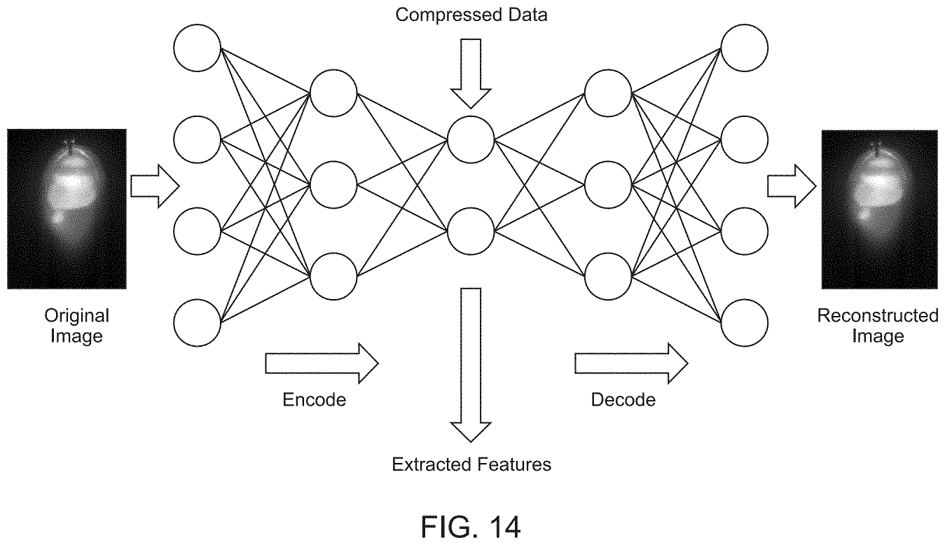

For distributed systems, the sharing of data between one or more manufacturing apparatus, one or more process monitoring sensors, machine vision systems, and/or in-process inspection tools may be facilitated through the use of a data compression algorithm, a data feature extraction algorithm, or a data dimensionality reduction algorithm. FIG. 14 illustrates one non-limiting example of an unsupervised ANN-based approach to image feature extraction and data compression, whereby image data is conveniently compressed, transmitted, and reconstructed at a different physical/geographical location from that at which it was acquired.

Processors & Computer Systems:

One or more processors may be employed to implement the machine learning algorithms, automated object defect classification methods, and manufacturing process control methods disclosed herein. The one or more processors may comprise a hardware processor such as a central processing unit (CPU), a graphic processing unit (GPU), a general-purpose processing unit, or computing platform. The one or more processors may be comprised of any of a variety of suitable integrated circuits, microprocessors, logic devices and the like. Although the disclosure is described with reference to a processor, other types of integrated circuits and logic devices may also be applicable. The processor may have any suitable data operation capability. For example, the processor may perform 512 bit, 256 bit, 128 bit, 64 bit, 32 bit, or 16 bit data operations. The one or more processors may be single core or multi core processors, or a plurality of processors configured for parallel processing.

The one or more processors, or the automated manufacturing apparatus and control system itself, may be part of a larger computer system and/or may be operatively coupled to a computer network (a “network”) with the aid of a communication interface to facilitate transmission of and sharing of data and predictive results. The network may be a local area network, an intranet and/or extranet, an intranet and/or extranet that is in communication with the Internet, or the Internet. The network in some cases is a telecommunication and/or data network. The network may include one or more computer servers, which in some cases enables distributed computing, such as cloud computing. The network, in some cases with the aid of the computer system, may implement a peer-to-peer network, which may enable devices coupled to the computer system to behave as a client or a server.

The computer system may also include memory or memory locations (e.g., random-access memory, read-only memory, flash memory), electronic storage units (e.g., hard disks), communication interfaces (e.g., network adapters) for communicating with one or more other systems, and peripheral devices, such as cache, other memory, data storage and/or electronic display adapters. The memory, storage units, interfaces and peripheral devices may be in communication with the one or more processors, e.g., a CPU, through a communication bus, e.g., as is found on a motherboard. The storage unit(s) may be data storage unit(s) (or data repositories) for storing data.

The one or more processors, e.g., a CPU, execute a sequence of machine-readable instructions, which are embodied in a program (or software). The instructions are stored in a memory location. The instructions are directed to the CPU, which subsequently program or otherwise configure the CPU to implement the methods of the present disclosure. Examples of operations performed by the CPU include fetch, decode, execute, and write back. The CPU may be part of a circuit, such as an integrated circuit. One or more other components of the system may be included in the circuit. In some cases, the circuit is an application specific integrated circuit (ASIC).

The storage unit stores files, such as drivers, libraries and saved programs. The storage unit stores user data, e.g., user-specified preferences and user-specified programs. The computer system in some cases may include one or more additional data storage units that are external to the computer system, such as located on a remote server that is in communication with the computer system through an intranet or the Internet.

Some aspects of the methods and systems provided herein, such as the disclosed object defect classification or manufacturing process control algorithms, are implemented by way of machine (e.g., processor) executable code stored in an electronic storage location of the computer system, such as, for example, in the memory or electronic storage unit. The machine executable or machine readable code is provided in the form of software. During use, the code is executed by the one or more processors. In some cases, the code is retrieved from the storage unit and stored in the memory for ready access by the one or more processors. In some situations, the electronic storage unit is precluded, and machine-executable instructions are stored in memory. The code may be pre-compiled and configured for use with a machine having one or more processors adapted to execute the code, or may be compiled at run time. The code may be supplied in a programming language that is selected to enable the code to execute in a pre-compiled or as-compiled fashion.

Various aspects of the technology may be thought of as “products” or “articles of manufacture” typically in the form of machine (or processor) executable code and/or associated data that is stored in a type of machine readable medium. Machine-executable code may be stored in an optical storage unit comprising an optically readable medium such as an optical disc, CD-ROM, DVD, or Blu-Ray disc. Machine-executable code may be stored in an electronic storage unit, such as memory (e.g., read-only memory, random-access memory, flash memory) or on a hard disk. “Storage” type media include any or all of the tangible memory of the computers, processors or the like, or associated modules thereof, such as various semiconductor memory chips, optical drives, tape drives, disk drives and the like, which may provide non-transitory storage at any time for the software that encodes the methods and algorithms disclosed herein.

All or a portion of the software code may at times be communicated via the Internet or various other telecommunication networks. Such communications, for example, enable loading of the software from one computer or processor into another, for example, from a management server or host computer into the computer platform of an application server. Thus, other types of media that are used to convey the software encoded instructions include optical, electrical and electromagnetic waves, such as those used across physical interfaces between local devices, through wired and optical landline networks, and over various atmospheric links. The physical elements that carry such waves, such as wired or wireless links, optical links, or the like, are also considered media that convey the software encoded instructions for performing the methods disclosed herein. As used herein, unless restricted to non-transitory, tangible “storage” media, terms such as computer or machine “readable medium” refer to any medium that participates in providing instructions to a processor for execution.

The computer system typically includes, or may be in communication with, an electronic display for providing, for example, images captured by a machine vision system. The display is typically also capable of providing a user interface (UI). Examples of UI's include, but are not limited to, graphical user interfaces (GUIs), web-based user interfaces, and the like.

Applications:

The disclosed automated object defect classification and adaptive, real-time manufacturing process control methods and systems may be used in any of a variety of industrial applications including but not limited to, the fabrication of parts and assemblies in the automotive industry, the aeronautics industry, the medical device industry, the consumer electronics industry, etc. For example, high volume applications for welding processes include use in the automotive industry for welding car bodies, as well as use in the oil and gas industry for construction of wells and refineries, and in the marine (shipbuilding) industry.

### EXAMPLES

These examples are provided for illustrative purposes only and not intended to limit the scope of the claims provided herein.

### Prophetic Example 1—Automated Object Defect Classification

The machine learning algorithm-based automated object defect classification methods and systems disclosed herein provide a key component for enabling adaptive, real-time additive manufacturing (or welding) process control. The methods comprise the use of a machine learning algorithm to analyze in-process or post-build inspection data for the purpose of identifying object defects and classifying them according to a specified set of fabrication quality criteria, and in some embodiments, further provide input data for real-time adaptive process control.

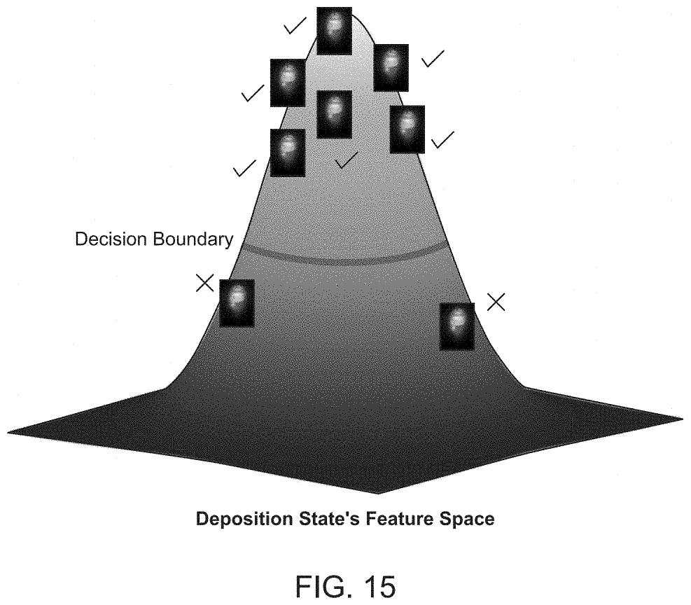

FIG. 15 provides a schematic illustration of the expected outcome for an unsupervised machine learning process for classification of object defects. One or more automated inspection tools, e.g., machine vision systems coupled with automated image processing algorithms, are used to monitor and measure feature dimensions, angles, surface finishes, and/or other properties of fabricated parts both in-process and post-build. Defects may be identified, e.g., by removing noise from the inspection data and subtracting a reference data set (e.g., a reference image of a defect-free part in the case that machine vision tools are being utilized for inspection), and classified using an unsupervised machine learning algorithm such as cluster analysis or an artificial neural network, to classify individual objects as either meeting or failing to meet a specified set of decision criteria (e.g., a decision boundary) in the feature space in which defects are being monitored. Tracking of the process control parameters and process monitoring data that were used to fabricate a set of objects (including both those that met the decision criteria and those that did not) provides training data for the machine learning algorithm used to run fabrication process control.

### Prophetic Example 2—Adaptive, Real-Time Additive Manufacturing Process Control

FIG. 10 shows one non-limiting example of an ANN architecture used for real-time, adaptive process control of an additive manufacturing (or welding) process. In FIG. 10, the input layer comprises one or more real-time streams of process and/or object property data that provide an indication of the current state of the fabrication process and/or the part being fabricated. Examples of suitable input data streams include, but are not limited to, process simulation data (e.g., FEA simulation data), process monitoring or characterization data, in-process inspection data, post-build inspection data, or any combination thereof, as well as a list of process control parameters that may be adjusted to implement next step actions to achieve a target (or future) fabrication state. This data is fed to the ANN, which in many cases has been previously trained using one or more training data sets comprising process simulation data, process monitoring or characterization data, in-process inspection data, post-build inspection data, or any combination thereof, from previous fabrication runs of the same or different types of parts. The hidden or intermediate layers of the ANN act as trained feature extractors, while the output layer in the example of FIG. 10 provides a determination of a predicted future build state. As noted above, the ANN model is trained to predict future build state based on current build state and a set of actions. Once the ANN model has been developed (i.e., the model can map current state and process parameters to a future state) it's use can be extended to the determination of a set of process control parameter adjustments for the next N states. The ANN model is a first step in creating an action-value function, and determining the next sequence of actions for a given build step (as depicted in FIG. 8) is a second step in developing adaptive, real-time process control.

In some embodiments, a neural network model may be used directly to determine adjustments to process control parameters. This will typically involve a more difficult “training” or “learning” process. Initially, the machine is allowed to choose randomly from a range of values for each input process control parameter or action. If the sequence of process control parameter adjustments or actions leads to a flaw or defect, it is scored as leading to an undesirable (or negative) outcome. Repetition of the process using different sets of randomly chosen values for each process control parameter or action leads to reinforcement of those sequences that least to desirable (or positive) outcomes. Ultimately, the neural network model “learns” what adjustments to make to a set or sequence of deposition process control parameters or actions in order to achieve the target outcome, i.e., a defect-free printed part.

### Example 3—Post-Process Image Feature Extraction and Correlation with Build-Time Actions

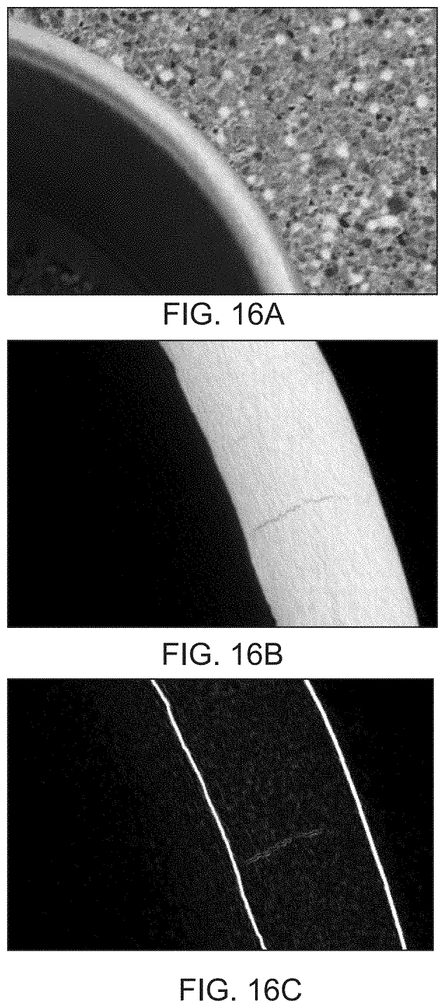

FIGS. 16A-C provide an example of in-process and post-process image feature extraction and correlation of part features with build-time actions. FIG. 16A: image of the part after the build process has been completed. FIG. 16B: example of post-build inspection output (in this case, a computerized tomography (CT) scan of the part). FIG. 16C: image obtained using a feature extraction algorithm to process the CT scan shown in FIG. 16B. In some embodiments, automated feature extraction allows one to correlate part features with build-time actions. During the build (e.g., when printing), in addition to building a machine learning model that correlates process control parameters (e.g., laser power, feed rate, travel speed, etc.) and result of the deposition process (e.g., the shape of melt pool, defects in the melt pool, etc.), one may also create a mapping between the process control parameters and a specific location in the part. This allows one to subsequently index post-build inspection data on the part and correlate findings from post-build inspection with process control parameters that are specific to a region of interest, thereby expanding the machine learning model to include post-build inspection data.

### Example 4—Exemplary Illustration of how the Use of a Machine Learning Approach Offers Improvements in Quality and/or Outcome as Compared to Conventional Fabrication Processes

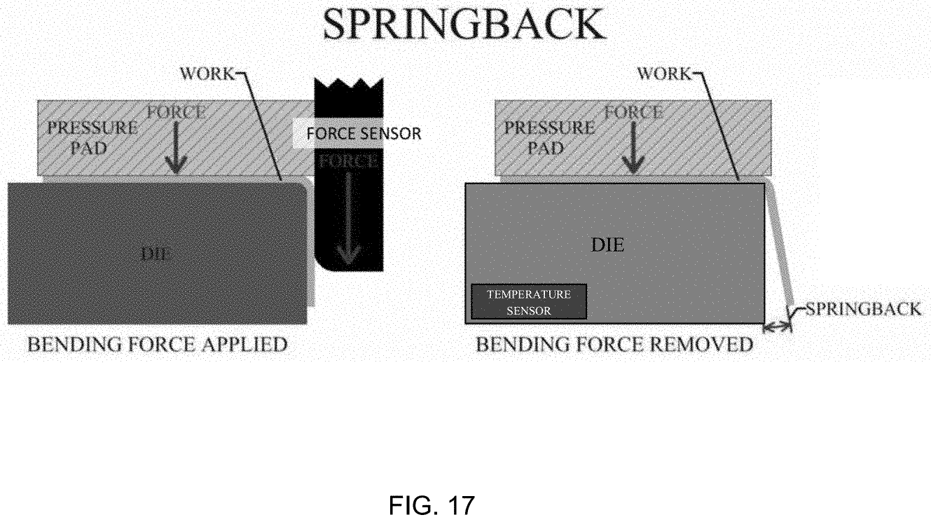

FIGS. 17-20 provide non-limiting examples how the machine learning approach offers improvements over conventional fabrication processes. By way of example, in conventional fabrication processes in connection with sheet metal bending machines, the bent metal can spring back to an undesired shape. However, as provided in FIG. 17, the machine learning approach described in the claimed methods and systems predicts and accounts for this spring back such that the bent metal springs to the desired shape. In some embodiments, the claimed methods and systems achieves this result by adjusting process parameters such as bend force, tool shape, bend speed, bend temperature, and/or bend pressure, or any combination thereof. Force, die shape, pad shape being modified to obtain desired shape after springback. Force measured dynamically during process (sensor). Springback being measured after process (camera, sensor, operator measurement).

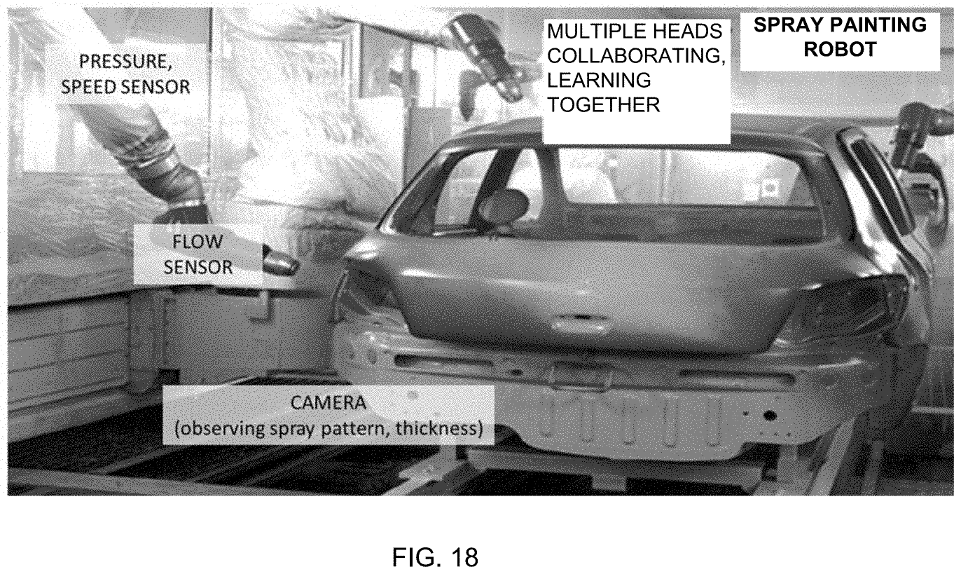

In another non-limiting example, there may be challenges associated with achieving a specific deposition thickness in connection with conventional spray processes. However, as provided in FIG. 18, the machine learning approach described in the claimed methods and systems predicts parameters such as spray duration, spray flow rate, spray nozzle shape, spray pressure, spray temperature, and/or spray tool speed to apply the desired deposition thickness, or any combination thereof. Parameters such as spray duration, spray follow rate, spray nozzle shape, spray pressure, spray temperature, and spray tool speed measured and modified as necessary during the spray process to obtain a desired thickness

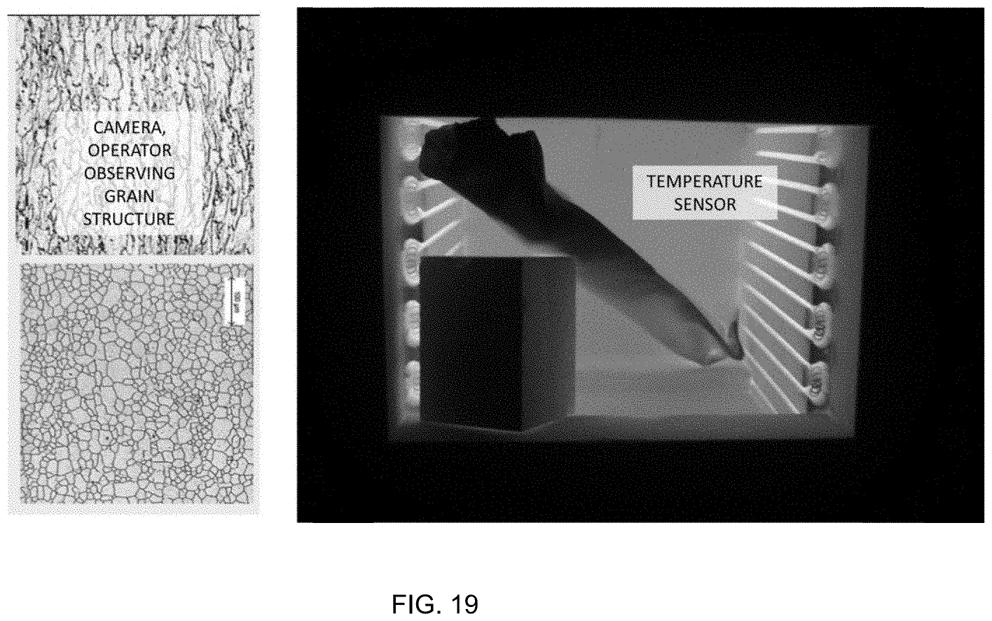

In another non-limiting example, there may be challenges associated with achieving a specific grain structure in connection with conventional processes regarding metallic heat treat process. However, as provided in FIG. 19, the machine learning approach described in the claimed methods and systems predicts parameters such as duration, temperature, heating rate, cooling rate, and/or pressure to obtain the specific grain structure, or any combination thereof.

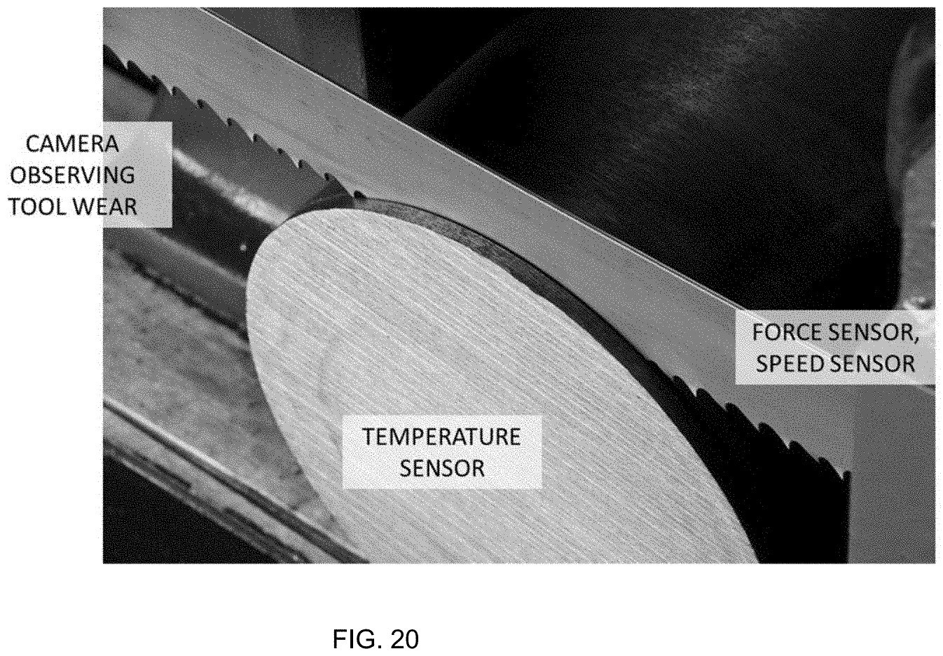

In another non-limiting example, there may be challenges associated with limiting heat to enter a part in connection with conventional cutting processes. However, as provided in FIG. 20, the machine learning approach described in the claimed methods and systems minimizes the operation time while under the constraint of a maximum heat input to the part. In some embodiments, this is obtained by modifying cut duration, cut tool force, cut temperature, and/or cut tool shape, or any combination thereof.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in any combination in practicing the invention. It is intended that the following claims define the scope of the invention and that methods and structures within the scope of these claims and their equivalents be covered thereby.

What is claimed is:

1. A method for real-time adaptive control of a manufacturing process, the method comprising:
a) providing an input design for an object;
b) providing a training data set, wherein the training data set comprises process simulation data, process characterization data, in-process inspection data, post-build inspection data, or any combination thereof, for a plurality of object designs or portions thereof that are the same as or different from the input object design of step (a);
c) providing a starting set or sequence of one or more manufacturing process control parameters for fabricating or assembling the object; and
d) performing the manufacturing process to fabricate or assemble the object, wherein real-time process characterization data or in-process inspection data is provided as input to a machine learning algorithm that has been trained using the training data set of step (b), and wherein the machine learning algorithm provides output values to adjust one or more manufacturing process control parameters in real-time.

2. The method of claim 1, wherein the starting set or sequence of one or more manufacturing process control parameters is derived using the machine learning algorithm that has been trained using the training data set of step (b).

3. The method of claim 1, wherein steps (b)-(d) are performed iteratively and process characterization data, in-process inspection data, or post-build inspection data for each iteration is incorporated into the training data set.

4. The method of claim 1, wherein the manufacturing process comprises an additive manufacturing process, a joining process, a forming process, a composite manufacturing process, a subtractive process, a surface preparation process, an inspection process, an assembly process, or any combination thereof.

5. The method of claim 4, wherein the additive manufacturing process comprises a deposition process, a chemical vapor deposition process, a painting process, a cold spray process, a high velocity oxygen fuel (HVOF) spraying process, an electrolytic coating process, a sculpting process, a cladding process, or any combination thereof.

6. The method of claim 4, wherein the joining process comprises a welding process, a bonding process, a micro-joining process, a hardfacing process, a butter welding process, or any combination thereof.

7. The method of claim 4, wherein the forming process comprises a forging process, an extrusion process, a sheet metal bending process, a superplastic forming process, a blow forming process, a hydroforming process, a break forming process, a casting process, a barreling process, a compacting process, a blooming process, a drawing process, a deep drawing process, a spring forming process, a winding process, a wire process, a knurling process, a rolling process, a saddling process, a spin forming process, an upsetting process, or any combination thereof.

8. The method of claim 4, wherein the composite manufacturing process comprises a filament winding process, a layup process, a molding process, an overwrapping process, or any combination thereof.

9. The method of claim 4, wherein the subtractive process comprises a cutting process, a turning process, a milling process, a drilling process, a boring process, a trepanning process, an ion beam milling process, a wet chemical etching process, a lithography process, a photochemical process, a dry etching process, an electro discharge machining process, a broaching process, a facing process, a polishing process, a lapping process, a pickling process, a reaming process, a piercing process, a tapping process, a blasting process, an abrasive process, a hobbing process, a ball milling process, a burnishing process, a linishing process, a comminution process, a grinding process, a crushing process, or any combination thereof.

10. The method of claim 4, wherein the surface preparation process comprises a painting process, a coating process, or any combination thereof.

11. The method of claim 4, where the inspection process comprises a non-destructive inspection process, an ultrasonic inspection process, an eddy current inspection process, an X-radiography process, a dye penetrant process, a magnetic penetrant process, an acoustic emission process, or any combination thereof.

12. The method of claim 4, wherein the assembly process comprises a press fit process, a tack weld process, a thermal fit process, a riveting process, a mechanical fastener process, or any combination thereof.

13. The method of claim 1, wherein the one or more manufacturing process control parameters are adjusted at a rate of at least 100 Hz.

14. The method of claim 1, wherein the method is implemented using either: (i) a single integrated system comprising a manufacturing apparatus, a sensor, and a processor; or (ii) a distributed, modular system comprising one or more manufacturing apparatus, one or more sensors, and one or more processors, wherein the one or more manufacturing apparatus, the one or more sensors, and the one or more processors are configured to share training data, real-time process characterization data, or real-time in-process inspection data via a local area network (LAN), an intranet, an extranet, or an internet.

15. The method of claim 1, wherein the training data set further comprises process characterization data, in-process inspection data, or post-build inspection data that is generated by an operator while manually adjusting the one or more manufacturing process control parameters.

16. The method of claim 1, wherein as part of the training of the machine learning algorithm, the machine learning algorithm randomly chooses values within a specified range for each of a set of one or more manufacturing process control parameters, and incorporates the resulting process simulation data, process characterization data, in-process inspection data, or post-build inspection data into the training data set to improve a learned model that maps manufacturing process control parameter values to manufacturing process outcomes.

17. A system for controlling a manufacturing process, the system comprising:
a) a first manufacturing apparatus, wherein the manufacturing apparatus is capable of fabricating all or a portion of an object based on an input design;
b) one or more manufacturing process characterization sensors, wherein the one or more manufacturing process characterization sensors provide real-time data for one or more manufacturing process parameters or object properties; and
c) a processor programmed to adjust one or more manufacturing process control parameters in real-time based on a stream of real-time process characterization data or in-process inspection data provided by the one or more manufacturing process characterization sensors, wherein the adjustments are derived using a machine learning algorithm that has been trained using a training data set.

19. The system of claim 17, wherein the one or more manufacturing process characterization sensors comprise at least one laser interferometer, machine vision system, or sensor that detects electromagnetic radiation that is reflected, scattered, absorbed, transmitted, or emitted by the object.

20. A method for automated classification of manufactured object defects, the method comprising:
a) providing a training data set, wherein the training data set comprises manufacturing process simulation data, manufacturing process characterization data, in-process inspection data, post-build inspection data, or any combination thereof, for a plurality of object designs that are the same as or different from that of the manufactured object;
b) providing one or more sensors, wherein the one or more sensors provide real-time data for one or more manufactured object properties; and
c) providing a processor programmed to provide a classification of detected manufactured object defects using a machine learning algorithm that has been trained using the training data set of step (a), wherein the real-time data from the one or more sensors is provided as input to the machine learning algorithm and allows the classification of detected manufactured object defects to be adjusted in real-time.
